(19) United States
(12) Patent Application Publication
(10) Pub. No.: US 2025/0137158 A1
(43) Pub. Date: May 1, 2025

(54) RARE EARTH METAL RECOVERY

(71) Applicant: DEAKIN UNIVERSITY, Victoria (AU)

(72) Inventors: Cristina Pozo-Gonzalo, Victoria (AU); Kalani Periyapperuma, Victoria (AU); Jennifer M. Pringle, Victoria (AU); Maria Forsyth, Victoria (AU)

(21) Appl. No.: 18/835,448

(22) PCT Filed: Feb. 3, 2023
(86) PCT No.: PCT/AU23/50072

§ 371 Date: Aug. 2, 2024

(30) Foreign Application Priority Data
Feb. 3, 2022 (AU) 2022900209

(51) Int. Cl. C25D 3/54

(52) U.S. Cl. CPC C25D 3/54

(57) ABSTRACT

A method of electrodepositing neodymium from a neodymium salt solution in ionic liquid and in the presence of transitional metal impurities which results in an improved electrowinning process wherein the electrochemical process occurring in the method produces a peak cathodic current density of −39 mA cm² or greater.

### FIELD OF THE INVENTION

The invention relates to improved recovery of the rare earth metal (REMs) neodymium (Nd) by electrodeposition under wet conditions at low temperatures.

### BACKGROUND

Rare earth metals (REMs) including neodymium (Nd) are a vital component in numerous modern technologies and applications including clean energy generation, transportation, and electronic devices due to their unique optical, electrical, and magnetic properties. In particular, neodymium, which is identified as a critical raw material, is in high demand for making permanent magnets for application in mobile phones, hard disk drives, wind turbines and electric motors in automobiles. In addition, it is also a constituent in the alloy anode material used in nickel-metal hydride batteries that fuel hybrid vehicles. Therefore, reliable and continuous access to these materials is essential. Extraction of Nd from primary mineral sources can result in substantial environmental impact during mining and processing. Additionally, the natural geographic distribution of REM reserves makes it challenging to maintain reliable access to these materials for production processes. Therefore, recovering REMs such as Nd from secondary sources such as end of life products is of increasing importance. Traditional hydrometallurgy and pyrometallurgy extraction and processing methods are often energy intensive and require large amounts of water and chemicals and produce a significant amount of secondary waste. Therefore, sustainable alternative methods to recover Nd from secondary sources are desirable.

Electrodeposition (electrowinning) is used to recover both base metals (e.g., Al, Zn, Ni) as well as precious metals (e.g., Pt, Ag). Different medias such as aqueous solution, organic media and advanced electrolytes such as ionic liquids and deep eutectic solvents have been used and investigated. Molten salts have also been commonly used but in this case high temperatures over 500° C. are required. The high negative reduction potentials of REMs (such as −2.66 V vs. SHE for Nd³⁺/Nd⁰) restrict the use of traditional aqueous solvents due to H₂ evolution as well as some organic media due to limited electrochemical stability. Therefore, finding chemically and thermally stable electrolytes to support Nd reduction with reasonable efficiencies in electrodeposition/electrowinning for Nd metal is challenging.

Ionic liquids, particularly bis(trifluoromethanesulfonyl)imide ([TFSI]⁻) anion based ILs, have been investigated for the recovery of Nd metal due to their preferred hydrophobic nature, relatively low viscosity and high conductivity. In the triethylpentylphosphonium IL, [P₂₂₂₅][TFSI], a decrease in overpotential for Nd³⁺ reduction at elevated temperatures has been observed and is attributed to an increase in charge transfer and mobility of electroactive species at high temperatures while reducing the Nd nucleation potential. In one study an electrodeposit comprised of both Nd metal and Nd₂O₃ was recovered at 150° C., which is a significantly lower temperature than traditional pyrometallurgical methods (>1000° C.). However, it was found that the presence of H₂O in the [P₂₂₂₅][TFSI] IL is unfavourable for Nd electrodeposition as it shifts the Nd³⁺ reduction potential to more negative values while reducing the cathodic current density suggesting water should be avoided. These results were thought to be due to the formation of stronger Nd³⁺—H₂O coordination complexes in the presence of H₂O than relatively weaker Nd³⁺-TFSI interactions which occur in absence of water. In contrast, an enhancement in current density by 3-fold (up to −5 mA cm⁻²) was reported with the addition of H₂O from 0.1 to 0.4 wt % in 0.1 m Nd(TFSI)₃ in [P_{666.14}][TFSI] IL electrolyte ([P_{666.14}]=trihexyltetradecylphosphonium). A non-fluorinated dicyanamide ([DCA]⁻) anion-based IL, [P_{666.14}][DCA] has been shown to support Nd electrodeposition in the presence of 0.1 molal Nd(OTf)₃ at 75° C. However, in comparison to [TFSI]-ILs, only sparse deposits were observed for this system, and this was attributed to strong coordination between Nd³⁺ and [DCA]-restricting the Nd³⁺ reduction process, suggesting [DCA] anions are less preferred for ILs used in Nd recovery by electrowinning.

PERIYAPPERUMA, K. et al., “Fluorine-free ionic liquid electrolytes for sustainable neodymium recovery using an electrochemical approach”, Green Chemistry, 2021, vol 23, pages 3410-3419, describes Nd recovery from a Nd nitrate salt in a model, impurity free wet electrolyte using a Ni working electrode. The method produces a Nd electrodeposit on a Ni working electrode wherein the method comprises a wet but completely non-Nd metal impurity free model ionic liquid electrolyte, whereby the method produces an electrodeposit having a ratio of Nd metal to Nd oxide of no better than 1:0.67. The best current density achieved is −37 mA cm⁻². while the reduction reaction has a peak cathodic potential of −2.3 V vs Fc/Fc+ and an onset potential of 1.75 V vs Fc/Fc+. Notably, this article reports a Ni Ka1 signal arises from the nickel working electrode used in the electrochemical process but there are no nickel impurities in the electrolyte.

There is therefore an ongoing need for improved methods of Nd recovery by electrodeposition, which at least partially addresses one or more of the above-mentioned short-comings, or provides a useful alternative providing purer products of ratio of Nd metal to Nd oxide.

In one preferred aspect, the invention seeks to provide a better-quality neodymium rich electrodeposit in terms of a higher purity elemental neodymium content in a quality neodymium electrodeposit (that is, provision of a neodymium rich electrodeposit) which comprises a ratio of neodymium metal (Nd⁰) to neodymium oxide (Nd₂O₃) which is 1:0.5 or better in favour or more elemental Nd in the deposit. More particularly, in a preferred aspect, the invention seeks to provide such a higher purity/quality neodymium electrodeposit in a highly efficient process (higher current density produced) at a substantially reduced energy burden (less negative reduction potential at the cathode) for the electrorecovery than possible for other Nd electrorecovery methods.

A reference herein to a patent document or other matter which is given as prior art is not to be taken as an admission that the document or matter was known or that the information it contains was part of the common general knowledge as at the priority date of any of the claims.

### STATEMENTS OF THE INVENTION

In one aspect of the invention, there is provided a method of electrodepositing neodymium from a neodymium salt solution, the method comprising the step of:
electrodepositing neodymium from an electrolyte composition comprising at least one neodymium (III) nitrate salt onto a conductive substrate by electrochemical reduction of neodymium onto the conductive substrate at a temperature of less than 100° C., wherein the electrolyte composition comprises:
   one or more ionic liquids comprising a non-halogenated anion, preferably a non-fluorinated anion,
   the at least one neodymium (III) nitrate salt, preferably at a concentration which is at a saturation concentration for the electrolyte composition,
   water at a concentration of up to and including 15 wt %, preferably up to and including 10 wt %, most preferably up to and including 5 wt % of the electrolyte composition, and
   one or more non-neodymium metal salt impurities selected from transition metal salt impurities, dissolved in the electrolyte composition as solvent, the impurities at a concentration of up to 40% (based on mol kg 1) of the neodymium salt for each metal salt impurity present.

In a first aspect of the invention, there is provided a method of electrodepositing neodymium from a neodymium salt solution, the method comprising the step of:
electrodepositing neodymium from an electrolyte composition comprising at least one neodymium (III) nitrate salt onto a conductive substrate by electrochemical reduction of neodymium onto the conductive substrate at a temperature of less than 100° C., wherein the electrolyte composition comprises:
   one or more ionic liquids comprising a non-halogenated anion, preferably a non-fluorinated anion,
   the at least one neodymium (III) nitrate salt in a concentration at a saturation concentration for the electrolyte composition,
   water at a concentration of up to and including 15 wt % of the electrolyte composition, and
   one or more non-neodymium metal salt impurities selected from transition metal salt impurities, dissolved in the electrolyte composition as solvent, the impurities at a concentration of up to 40% (based on mol kg⁻¹) of the neodymium salt for each metal salt impurity present,
wherein the neodymium electrodeposit formed comprises a ratio of neodymium metal (Nd⁰) to neodymium oxide (Nd₂O₃) of 1:0.5 or better in favour of greater neodymium metal (Nd⁰) in the electrodeposit.

Suitably, the deposit is formed from an electrodeposit process running for a period of at least 2 h, or at least 2.5 h, or at least 3 h, or at least 3.5 h, or at least 4 h. In some embodiments, the deposit is formed from an electrodeposit process running for a period of less than 3.5 h, or less than 3 h, or less than 2.5 h, or less than 2 h, or of from 1 h to 3 h, or of from 0.5 h to 3.5 h, or of from 0.5 h to 3 h, or of from 0.5 h to 2.5 h, or of from 10 min to 3 h, or of from 10 min to 2.5 h.

Desirably, after the electrodeposition process, the electrodeposit formed comprises a ratio of neodymium metal (Nd⁰) to neodymium oxide (Nd₂O₃) which is 1:0.65 or better, 1:0.6 or better, 1:0.5 or better, 1:0.45 or better, 1:0.4 or better, 1:0.35 or better, 1:0.30 or better, 1:0.25 or better, 1:0.20 or better, in favour of greater neodymium metal (Nd⁰) in the electrodeposit. The ratio of neodymium metal (Nd⁰) to neodymium oxide (Nd₂O₃) can be determined by any suitable method known to the person skilled in the art, however, herein the ratio has been determined by XPS surface and depth profiling studies considering amounts in terms of atomic %, that is, etching studies and Nd 3d_{5/2} region spectra analysis. Using this method, evidence for the presence of Nd metal (979-980 eV) and Nd₂O₃ (>982 eV) can be observed at any exposed surface of the electrodeposit, such as at the surface of the electrodeposit in contact with the electrolyte where no etching is required, but also increasingly deep inner layers through the use of etching into the bulk electrodeposit. Accordingly, as used herein, the term “ratio” in relation to the relative amount of Nd(0) to Nd₂O₃ may refer to a ratio calculated on the basis of atomic percentages of Nd(0) and Nd(III) in the form of Nd₂O₃ present in the electrodeposit.

The phrase “comprises a ratio” in the context of the electrodeposit may refer in some embodiments to the electrodeposit having a ratio of Nd(0) to Nd₂O₃ of 1:0.65 or better, 1:0.6 or better, or 1:0.5 or better in favour of greater amounts of neodymium metal (Nd⁰) in the electrodeposit, after ion beam etching the electrodeposit in a single spot for a period of time of 60 seconds or more, of 90 seconds or more, of 120 seconds or more, of 180 seconds or more, or of 270 seconds or more or of at least 180 s, or a period of at least 270 s, or for a period of 180 s, or for a period of 270 s, or for a period of from 120 s to 270 s, or of from 180 s to 270 s. Etching for periods of time of at least 120 s, or of at least 180 s, or of at least 270 s, may advantageously avoid measuring surface contamination effects, such as oxidation after the electrodeposit is removed from the electrolyte environment. In one embodiment, etching is for a sufficient period of time to reach a depth of the electrodeposit where the composition stabilises, such as where concentrations measured at consecutive depths agree to within 5%, or to within 10%, or to within 15%, or to within 20% of each other.

In one embodiment, the ratio is measured on an electrodeposit as formed after 3.5 h of run time in the electrodeposition circuit at a depth corresponding to an etch time of about 180 s. In one embodiment, the ratio is measured on an electrodeposit as formed after 3.0 h of run time in the electrodeposition circuit at a depth corresponding to an etch time of about 270 s. In one embodiment, the ratio is measured on an electrodeposit as formed after 3.5 h of run time in the electrodeposition circuit at a depth corresponding to an etch time of about 270 s. In one embodiment, the ratio is measured on an electrodeposit as formed after between 3 and 3.5 h of run time in the electrodeposition circuit at a depth corresponding to an etch time of from about 180 s to 270 s. In one embodiment, the ratio is measured within the electrodeposit layer, rather than at the surface of the electrodeposit layer. In one embodiment, the ratio is measured within the electrodeposit layer, rather than at the surface of the electrodeposit layer, such as at a distance above the surface of the electrode corresponding to 25% of the total thickness of the electrodeposit layer, or at a distance above the surface of the electrode corresponding to 30%, 35%, 40%, 45%, 50%, 55%, 60%, 65%, 70%, 75% or 80% of the total thickness of the electrodeposit layer. In some embodiments, this electrodeposit distance above the surface of the electrode is measured after the electrodeposition circuit has run for a period of 3.5 h, or 3 h, or 2.5 h, or 2 h, or 1.5 h.

In preferred embodiments, the electrodeposit formed in the methods described herein has a greater ratio of neodymium metal (Nd⁰) to neodymium oxide (Nd₂O₃), meaning a greater proportion of neodymium metal (Nd⁰), in the electrodeposit when compared to an equivalent electrodeposit formed in an equivalent method devoid of non-Nd metal salt impurities dissolved in the electrolyte composition when measured under the same conditions. For the avoidance of doubt, the equivalent method refers to all parameters in the electrodeposition process being identical except for the presence of the non-neodymium metal salt impurities. The equivalent method may also refer to an equivalent analysis method, such as the analysis method selected to detect the metal and metal oxide content of the electrodeposit/quantitatively determine the amount of the Nd metal and ND oxide present in the electrodeposit. In one embodiment, the electrodeposit formed in the methods described herein has a greater ratio of neodymium metal (Nd⁰) to neodymium oxide (Nd₂O₃) in favour of greater neodymium metal (Nd⁰) in the electrodeposit after the electrodeposition has been running for a period of 3.5 h, or 3 h, or 2.5 h, or 2 h, or 1.5 h, after an ion beam etch time of 120 s, or of 180 s, or of 270 s, when compared to an equivalent electrodeposit formed in an equivalent method devoid of non-Nd metal salt impurities dissolved in the electrolyte composition when measured under the same conditions.

In other embodiments, the ratio may be a ratio of averages, where the neodymium metal (Nd⁰) to neodymium oxide (Nd₂O₃) ratio of averages is 1:0.75 or better, 1:0.65 or better, 1:0.6 or better, or 1:0.5 or better in favour of greater amounts of Nd(0). In some embodiments, the ratio of averages is calculated by determining the atomic composition of the electrodeposit at more than 1, such as 2, 3, 4, 5, 6, 8, or 10 or more different depths within the electrodeposit and averaging their concentrations, then calculating the ratio. In one embodiment, the different depths correspond to etching times of 0 s, 60 s, 90 s, 120 s, 180 s and 270 s at a single spot, especially at 90 s, 120 s, 180 s and 270 s at a single spot. In preferred embodiments, the ratio of averages closely approximates or reflects the bulk composition of the electrodeposit. In one embodiment, the ratio is a relative ratio accounting only for the presence of Nd(0) and Nd₂O₃; that is, disregards the concentration of any other species present in the electrodeposit.

In other embodiments, the electrodeposit described herein may comprise at least one region in which a ratio of neodymium metal (Nd⁰) to neodymium oxide (Nd₂O₃) is 1:0.5 or better, or 1:0.4 or better, or 1:0.3 or better, or 1:0.2 or better, in favour of greater neodymium metal (Nd⁰), is present. The region in this embodiment may be as measured using XPS as described above, or using any other method, at any location within the electrodeposit, such as at any one location within the electrodeposit.

It will be understood the non-Nd metal salt impurity does not arise from any conductive substrate (e.g. from leaching or the like) used as working electrode in the cell, for example, a Ni working electrode onto which the electrodeposit is formed. The impurity must be in the electrolyte used, either added to a desired quantity or present in the desired quantity as a result of one or more preceding processing steps, for example, which may occur in a recycling method.

In some embodiments, the Nd₂O₃ atomic concentration (at %) present increases with sample (electrodeposit) depth moving away from the working electrode surface while metallic Nd concentration decreases with sample (electrodeposit) depth moving away from the working electrode surface. This is particularly the case for a Co²⁺ impurity. In the electrodeposit resulting from the Ni²⁺ containing Nd-electrolyte, a relatively higher metallic Nd concentration is observed compared to that of the Nd₂O₃ at all depths of the electrodeposit on the working electrode surface.

In contrast, the electrodeposit obtained from the solution in the absence of Co²⁺ and Ni²⁺ impurities, a larger amount of Nd₂O₃ was observed with a ratio Nd metal: Nd₂O₃ of 1:0.7. Therefore, in comparison to the electrodeposit resulting from the absence of the impurities, a higher amount of elemental Nd than Nd₂O₃ ratio are produced than for the non-impurity electrolyte.

In some embodiments, the non-neodymium metal impurity is present at a concentration of from about 15% to about 30% (based on mol kg 1) of the neodymium salt for each metal salt impurity present. In some embodiments, the salt impurity is a Co and/or a Ni salt.

Preferably, the salt impurity is a cobalt salt impurity is present at a concentration of up to about 0.15 mol kg⁻¹. Thus, in some embodiments the cobalt salt impurity, is present at a concentration of up to about 20% of the Nd content based on mol/kg. In some embodiments the cobalt salt impurity, preferably, is present at a concentration of up to about 3 wt % of the electrolyte composition.

Suitably, the salt impurity is a nickel salt impurity. Desirably, the nickel salt impurity, is present at a concentration of up to 0.1 mol kg⁻¹. Thus, in some embodiments the nickel salt impurity is present at a concentration of up to about 30% of the Nd content based on mol/kg. In some embodiments the nickel salt impurity is present at a concentration of up to about 3 wt % of the electrolyte composition.

In preferred embodiments, the electrochemical step, or more appropriately, the electrochemical reduction reaction taking place in the method, preferably produces a peak cathodic current density of at least −39 mA cm⁻² at a working electrode in a cell comprising the electrolyte composition, though even greater/higher peak cathodic densities are particularly preferred. By “higher” in this instance, it will be understood that means more negative values of current density are preferred. In some embodiments, the peak cathodic current may be readily determined by cyclic voltammetry (CV) studies on the electrolyte composition/system used in the method. In some embodiments involving cyclic voltammetry studies, a potential range is applied and scanned to determine the peak current density under a particular set of conditions. Thus, once the particular conditions used to provide the highest peak current density are identified, they may then be then applied during an actual electrodeposition process. Such CV methods are well known to the skilled electrochemist. In some embodiments, the peak current cathodic current density achievable for any given system can be determined by cyclic voltammetry studies on the electrolyte/system, preferably at a scan rate of 100 mV s⁻¹, most preferably at 50° C., for example, using a nickel working electrode.

Desirably, the electrodeposit comprises Nd and/or Nd₂O₃ throughout the depth of the electrodeposit. It is believed the Nd₂O₃ is electrochemically generated during the reduction process occurring at the working electrode. The electrodeposit produced, particularly after about 3 hours, preferably covers more than 75%, more than 80%, more than 85%, more than 90% or more than 95% of the surface of the conductive substrate, that is, the working electrode, suitably a nickel working electrode for example. The deposit and composition thereof, may be further varied/improved by tailoring one or more of the deposition time, the potential, electrolyte composition and the substrate used.

In some embodiments, surprisingly, the impurity is deposited simultaneously with Nd, rather than depositing first on the substrate surface as expected due to lower reduction potential. This is particularly the case for cobalt as an impurity metal.

In a second aspect, the invention provides an electrolyte composition for neodymium electrodeposition by electrochemical reduction of neodymium onto a conductive substrate at a temperature of less than 100° C., the composition comprising:
an ionic liquid comprising a non-halogenated anion, preferably a non-fluorinated anion;
at least one neodymium (III) nitrate salt in a concentration at a saturation concentration for the electrolyte,
water at a concentration of up to and including 15 wt % of the composition, and
one or more non-neodymium metal salt impurities selected from transition metal salt impurities, dissolved in the electrolyte composition as solvent, the impurities at a concentration of up to 40% (based on mol/kg) of the neodymium salt for each metal salt impurity present.

In a third aspect, the invention provides recovered neodymium in the form of one or more of neodymium metal (Nd⁰) and neodymium oxide (Nd₂O₃) obtainable or obtained by the method of the first aspect. Suitably, the recovered neodymium is free of halogenated neodymium salt, more preferably free of fluorinated neodymium salt, preferably, NdF₃ free.

In a fourth aspect, the invention provides electrochemically recovered neodymium of the third aspect for use in applications such as energy generation, transportation, and electronic device applications. Desirably such applications include a permanent magnet for example in mobile phones, hard disk drives, wind turbines and electric motors in automobiles or in an alloy anode material for a nickel-metal hydride batteries, for example, that fuel hybrid vehicles.

In some embodiments, the water is present in an amount of up to about 50,000 ppm, up to about 47,000 ppm, up to about 46,000 ppm, up to about 45,000 ppm, up to about 40,000 ppm, up to about 30,000 ppm, up to about 20,000 ppm, up to about 10,000 ppm. Higher concentrations of water in the electrolyte are particularly preferred, for example around 40,000 to about 50,000 ppm, most preferably about 44,000 to 47500 ppm. In some embodiments, water is present at a concentration of around 46,000 ppm.

### BRIEF DESCRIPTION OF THE DRAWINGS

Embodiments of the invention will herein be illustrated by way of example only with reference to the accompanying drawings in which:

FIG. 1 illustrates the electrochemical window for neat (a) [C₄mpyr][DCA] and (b) [P₁₂₂₂][FSI] and the electrochemical reduction behaviour of Nd³⁺ in Nd(OTf)₃ and Nd(NO₃)₃·6H₂O salts with (c,d,e) [C₄mpyr][DCA] and (f) [P₁₂₂₂][FSI] on Ni metal and GC working electrodes at 50° C. Scan rate: 100 mV s⁻¹. This figure demonstrates the electrochemical performance in a model system without presence of transition metal salt impurities which is required by the present invention to observe the improved method;

FIG. 2 illustrates a comparison of (a) onset reduction potentials for Nd³⁺ and (b) peak current densities on Ni metal substrate working electrode extracted from FIG. 1 for the model system without non-Nd metal impurities in the electrolyte. This figure also demonstrates the electrochemical performance in a model system without presence of non-Nd transition metal salt impurities which is required by the present invention to observe the improved method. The nitrate salt system in the non-fluorinated IL of the model system gives the better performance with the best performance (a peak current density of about −37.5 mA cm⁻²) observed when at the higher concentration (saturation concentration of the Nd salt), an onset reduction potential of only about −1.75 V for of 0.5 molal Nd(NO₃)₃·6H₂O;

FIG. 3 illustrates the electrochemical behaviour of (a) 0.2 mol kg⁻¹ Nd(NO₃)₃·6H₂O and Nd(OTf)₃ with 2.3 wt % H₂O and (b) 0.5 and 0.2 mol kg⁻¹ Nd(NO₃)₃·6H₂O with 4.7 wt % H₂O in [C₄mpyr][DCA] at 50° C. on a Ni metal substrate as working electrode. The dotted line voltammogram represents the electrochemical behaviour of 0.2 mol kg⁻¹ Nd(OTf)₃ and Nd(NO₃)₃·6H₂O solutions as prepared. This figure also demonstrates the electrochemical performance in a model system without presence of non-Nd transition metal salt impurities;

FIG. 4 illustrates SEM images (top two rows) and EDX mapping (bottom two rows) showing Ni and Nd on the electrodeposits resulting from (a,d,e,f) 0.2 mol kg⁻¹ Nd(OTf)₃ in [C₄mpyr][DCA] (−2.94 V vs Fc^{0/+}), (b,g,h,i) 0.5 mol kg⁻¹ Nd(NO₃)₃·6H₂O in [C₄mpyr][DCA] (−2.24 V vs Fc^{0/+}) and (c,j,k,l) 0.1 mol kg⁻¹ Nd(NO₃)₃·6H₂O in [P₁₂₂₂][FSI] (−2.20 V vs Fc^{0/+}) electrolytes on a Ni working electrode substrate at 50° C. This figure also demonstrates the electrodeposition performance in a model system without presence of transition metal salt impurities. The superior electrodeposits formed in the non-fluorinated ionic liquid are evident from the SEM/EDX images in the first two columns. The thicker deposit is achieved in the 0.5 m Nd nitrate salt system utilising the non-fluorinated ionic liquid as the Ni substrate is barely shown;

FIG. 5 illustrates Nd 3d_{5/2} region spectra and the comparison of Nd metal and Nd₂O₃ content after 0, 90, 180 and 270 s of etching time on the Nd electrodeposits resulting from (a-e) 0.2 mol kg⁻¹ Nd(OTf)₃ and (f-j) 0.5 mol kg⁻¹ Nd(NO₃)₃·6H₂O in [C₄mpyr][DCA] IL electrolytes. This figure also demonstrates the electrodeposition performance in terms of relative ratios of Nd to Nd oxide in the deposit in a model system without presence of non-Nd metal transition metal salt impurities. It can be seen that the nitrate salt model system results in a higher ratio of Nd metal to the Nd oxide in the deposit compared to the Nd triflate model system;

FIG. 6 illustrates the cyclic voltammograms for 0.5 mol kg⁻¹ Nd(NO₃)₃·6H₂O in [C₄mpyr][DCA] IL electrolyte with (a) 0.15 mol kg⁻¹ CoCl₂·6H₂O and (b) 0.1 mol kg⁻¹ Ni(OTf)₂. Same concentrations are used for unmixed solutions. Scan rate=100 mV s⁻¹, T=50° C. This figure demonstrates the electrodeposition performance in the impurity system where non-Nd transition metal salt impurities are present in non-trivial amounts. It is evident from this figure that the non-trivial amounts of impurities in the presence of substantial amounts of water in the ionic liquid improved the performance of the electrodeposition significantly producing a much higher peak current density for the reaction and at a more positive reduction potential, signifying an easier and very efficient reduction in the described system. In particular, the cobalt impurity system in the non-fluorinated IL electrolyte composition gives particularly impressive results. The results are surprising as there is a prejudice in the art that water should be removed from the electrolyte, and that during processing, non-Nd metal and other impurities should be reduced as far as possible, or indeed eliminated entirely, to avoid interference in the Nd reduction reaction at the working electrode. The data show that for some reason the electrolyte with high water and high impurity content gives a more efficient and less energetically demanding Nd ion reduction, that is, to Nd metal/Nd oxide. The data show that water and non-Nd transition metal impurities should not be reduced/removed prior to electrodeposition;

FIG. 7 illustrates SEM images (top row) and EDX mapping (bottom row) for Nd electrodeposits resulting from 0.5 mol kg⁻¹ Nd(NO₃)₃·6H₂O in [C₄mpyr][DCA] IL electrolyte with (a, c and d) 0.15 mol kg⁻¹ CoCl₂·6H₂O at −2.15 V vs Fc^{0/+} and (b, e and f) 0.1 mol kg⁻¹ Ni(OTf)₂ at −2.25 V vs Fc^{0/+}. Substrate Ni foil, 3.5 h deposition time and working temperature: 50° C.;

FIG. 8 illustrates Nd 3d_{5/2} region in XPS spectra and the comparison of Nd metal and Nd₂O₃ content after 0, 60 and 270 s etching time on the Nd electrodeposits resulting from 0.5 mol kg⁻¹ Nd(NO₃)₃·6H₂O in [Campyr][DCA] IL electrolyte with (a-d) 0.15 mol kg⁻¹ CoCl₂·6H₂O and (e-h) 0.1 mol kg⁻¹ Ni(OTf)₂. This figure demonstrates the electrodeposition performance in the impurity system where transition metal salt impurities are present in terms of the ratio of Nd to Nd oxide in the deposit. It is evident from this figure that the impurities system result in a significantly higher ratio of Nd metal to Nd oxide than the best model system without impurities present. This means that unexpectedly, a higher quality deposit is produced, in terms of the quantity of elemental Nd present versus Nd oxide, using the methods of the invention which involve saturated Nd nitrate salt in the presence of high levels of water and a non-Nd transition metal impurity. The results are surprising as there is a prejudice in the art that water should be removed from the electrolyte, and that during processing, non-Nd metals and other impurities should be reduced as far as possible, or indeed eliminated entirely, to avoid interference in the Nd reduction reaction at the working electrode. The method described herein represents an advance in elemental Nd recovery due to the higher purity of the recovered Nd in the electrodeposit, which is achieved using a more efficient process at a substantially reduced energy burden for the electrorecovery;

FIG. 9 illustrates Co 2p region in XPS spectra after 0, 60 and 270 s of etching time on the electrodeposit resulting from 0.5 mol kg⁻¹ Nd(NO₃)₃·6H₂O in [Campyr][DCA] IL electrolyte with (a-c) 0.15 mol kg⁻¹ CoCl₂·6H₂O and (d) 0.1 mol kg⁻¹ Ni(OTf)₂; and

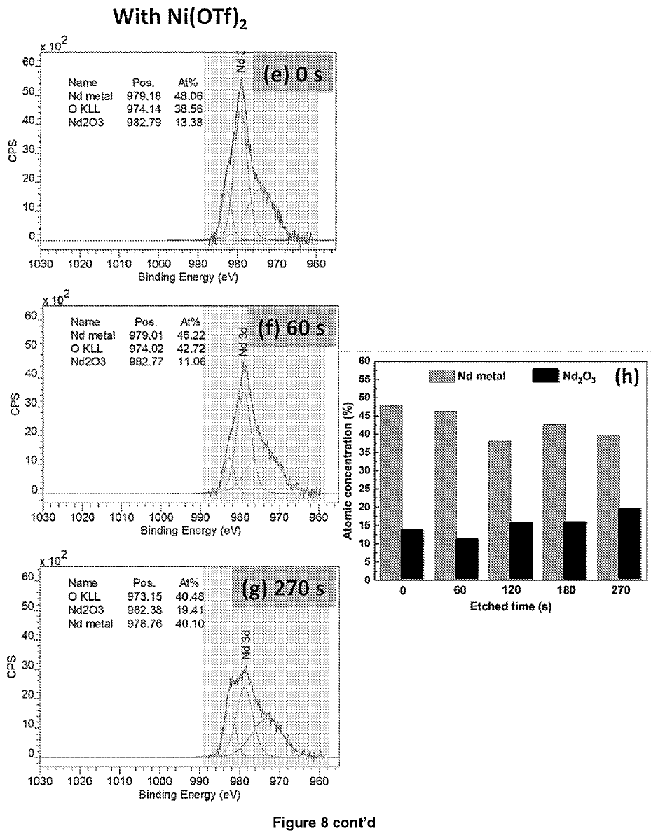

FIG. 10 illustrates chronoamperometric profiles for Nd electrodeposition in 0.2 m Nd(OTf)₃ (−2.94 V vs Fc^{0/+}) and 0.5 m Nd(NO₃)₃·6H₂O (−2.24 V vs Fc^{0/+}) in [Campyr][DCA] electrolytes on Ni metal at 50° C.

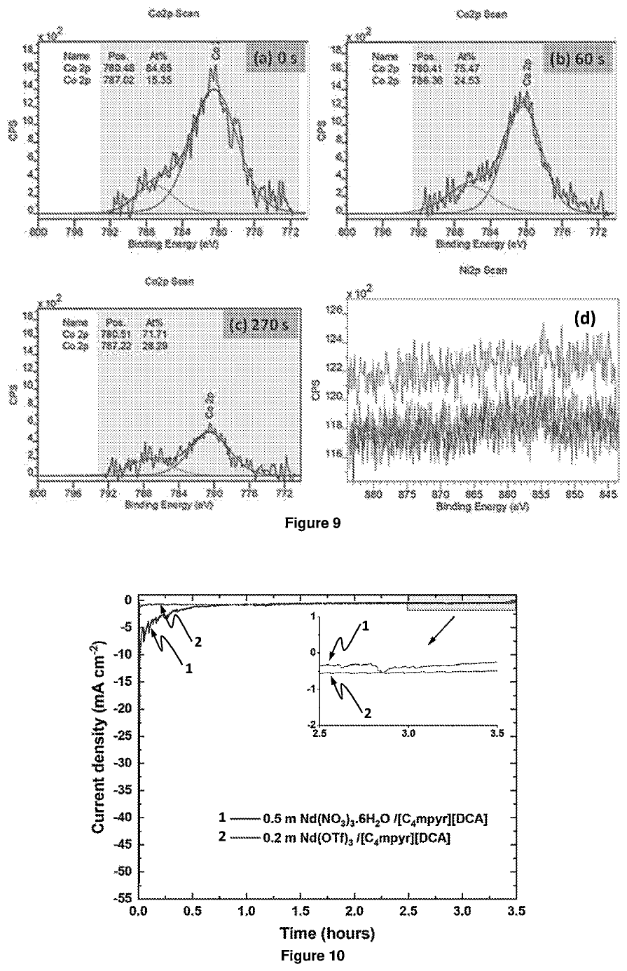

### DETAILED DESCRIPTION OF THE INVENTION

The invention relates to an improved method of electrodepositing neodymium from a neodymium nitrate salt solution, which for example, can arise from leached end of life products comprising Nd, whereby Nd recovery occurs in the presence of common impurities from end-of-life products such as permanent batteries and nickel hydride batteries.

The invention seeks to provide a better-quality neodymium electrodeposit in terms of a higher purity elemental neodymium content (Nd rich) in a neodymium electrodeposit (that is, provision of a neodymium electrodeposit which comprises a ratio of neodymium metal (Nd⁰) to neodymium oxide (Nd₂O₃) which is greater than 1:0.7 and more preferably greater than 1:0.5 or better in favour of more elemental Nd. More particularly, the problem is how to provide such a higher purity/quality neodymium electrodeposit in a highly efficiently process at a substantially reduced energy burden for the electrorecovery than possible for convention Nd electrorecovery methods. The inventors have found that such a better-quality neodymium electrodeposit can be produced through use of an electrolyte for Nd electrodeposition that involves a saturated Nd nitrate salt, in the presence of high levels of water and non-Nd transition metal impurities.

It was not expected that a neodymium electrodeposit which comprises a ratio of neodymium metal (Nd⁰) to neodymium oxide (Nd₂O₃) which is greater than 1:0.75, greater than 1:0.65, and more preferably greater than 1:0.6, or more preferably greater than 1:0.5 or better in favour of more elemental Nd could be produced using a method that is more efficient, that is, proceeds at a substantially reduced energy burden for the electrorecovery, than possible for conventional Nd electrorecovery methods.

The results are surprising as there is a prejudice in the art that water should be removed from the electrolyte, and that during processing, non-Nd metal and other impurities should be reduced as far as possible, or indeed eliminated entirely, to avoid interference in the Nd reduction reaction at the working electrode. Even so, there is nothing to suggest that the electrolytes described herein would result in an advance in elemental Nd recovery due to the higher purity of the recovered Nd in the electrodeposit, which is achieved using a more efficient process at a substantially reduced energy burden for the electrorecovery.

The method comprises the step of: electrodepositing neodymium from an electrolyte composition comprising at least one neodymium (III) nitrate salt onto a conductive substrate by electrochemical reduction of neodymium onto the conductive substrate at a temperature of less than 100° C., wherein the electrolyte composition comprises: one or more ionic liquids comprising a non-halogenated anion, preferably a non-fluorinated anion, the at least one neodymium (III) nitrate salt, preferably at a concentration which is at a saturation concentration for the electrolyte composition, water at a concentration of up to and including 15 wt %, preferably up to and including 10 wt %, most preferably up to and including 5 wt % of the electrolyte composition, and one or more non-neodymium metal salt impurities selected from transition metal salt impurities, dissolved in the electrolyte composition as solvent, the impurities present at a concentration of up to 40 wt % of the neodymium salt for each metal salt impurity present.

The present invention provides a convenient and cost-effective electrodeposition method for neodymium metal and/or neodymium oxide recovery from a neodymium nitrate salt containing solution/electrolyte. The invention represents a significant advance over existing commercial/industrial methods for recovery Nd, in terms of process ease, convenience, cost and performance. The method has surprising efficacy compared to existing Nd recovery methods in particular when the low working temperature and/or higher tolerance to water possible are considered. The method thus provides convenient access to recovered Nd materials which are vital for supporting green energy technologies such as wind turbines and electric vehicles. The quality of recovered materials are vital for supporting green energy technologies such as wind turbines and electric vehicles. It is believed that the use of Nd nitrate in a non-fluorinated ionic liquid in presence of other non-Nd metal impurities such as Co and Ni salts allows surprisingly easy recovery of neodymium by electrowinning that readily reduces Nd ions to form recovered Nd in the form of a deposit of Nd metal/Nd oxide deposit on a desired conductive surface. The quality of the deposits formed using the methods of the invention cannot be achieved by existing methods at such low working temperature and with such a high tolerance to water as is possible for the present invention. This presents the method of the invention with advantages in terms of ease of commercialization as it uses a low cost, more environmentally friendly electrolyte media, less energetic working conditions in the recovery process and the tolerance of water which allow for the process to be used in non-controlled working environment, e.g., in air. Additionally, the improved recovery only requires the presence of common transition metal salt impurities which can be removed conveniently avoiding the need for previously required separation steps.

The inventors have developed an excellent method for successfully recovering neodymium metal and neodymium oxide in the form of an electrodeposit using a non-halogenated ionic liquid based electrolyte composition, preferably a low cost, fluorine free (i.e., environmentally friendly) ionic liquid such as N-butyl-N-methylpyrrolidinium dicyanamide ionic liquid which is used as electrolyte in an electrowinning/electrodeposition process. The method is carried out in the presence of common transition metal impurities, such as those arising from spent nickel metal hydride batteries or magnets, for example, in concentrations up to 40 wt % of the Nd salt concentration for each non-Nd metal impurity. Unexpectedly, larger improved Nd/Nd oxide deposits were attained (corresponding to higher cathodic current densities) and in some cases at less negative potentials, in the presence of such impurities than in model systems containing only Nd nitrate salt. For example, the charge density passed is double in the presence of Ni as impurity and four times higher in the case of the cobalt impurity system. Furthermore, in the system with the impurities, it was unexpected that the electrodeposit arising from the impurities system would have a particularly high ratio of Nd metal to Nd oxide. The improved process observed with impurities was unexpected/surprising given less favourable mass transport (e.g., viscosity and conductivity) would be expected in the presence of both Nd³⁺ and Co²⁺, affecting both the kinetics and thermodynamics of the reduction process. This could be related to more favourable Nd speciation in the presence of cobalt salt, or a catalytic effect of cobalt in the electrochemical process.

In preferred embodiments, the neodymium was successfully recovered by electrodeposition at low operating temperatures of around 100° C. or less, more preferably around 75° C. or less and most preferably around 50° C. or less making the recovery process more sustainable and less energy intensive that existing Nd recovering methods which use much higher temperatures well over 100° C.

In preferred embodiments, the inventors have found that Nd metal can be successfully electrodeposited from certain neodymium salts in non-halogenated, non-fluorinated ILs at relatively low temperatures of less than 100° C. using undried electrolytes having significant moisture contents as described herein.

A preferred method of the invention corresponds to the first aspect of the invention as described above. It will be understood the conductive substrate is an electronically (electrically) conductive substrate.

It will further be understood that an ionic liquid is a salt entirely composed of ions whereby the material in the liquid state having a melting point of below 100° C. Preferred ionic liquids are molten/in liquid form below 75° C., and more preferably below 60° C.

Desirably, the method further comprising the step of:
recovering neodymium from the electrodeposit on the conductive substrate.

Suitably, neodymium is recovered from the electrodeposit as a mixture of one or more of neodymium metal (Nd⁰) and neodymium oxide (Nd₂O₃). Suitably, the neodymium may be recovered from the electrodeposit as a mixture of one or more of neodymium metal (Nd⁰) and neodymium oxide (Nd₂O₃). In some embodiments, the deposit comprises a higher ratio of Nd metal to Nd oxide. In some embodiments, the deposit comprises more Nd metal, such as on an atomic % basis, than Nd oxide. In some embodiments, the electrodeposit comprises between 1:0.3 and 1:1 neodymium metal (Nd⁰) to neodymium oxide (Nd₂O₃). In some embodiments, the electrodeposit has greater than a 1:1 ratio, greater than a 1:0.75 ratio, greater than a 1:0.67 ratio, greater than a 1:0.65 ratio, greater than a 1:0.6 ratio, greater than a 1:0.5 ratio, greater than a 1:0.3 ratio of neodymium metal (Nd⁰) and neodymium oxide (Nd₂O₃), in favour of neodymium metal (Nd⁰).

In a preferred embodiment, at least one neodymium (III) nitrate salt is present in a concentration which is a saturation concentration for the particular Nd salt in the particular electrolyte composition being used. In some preferred embodiments, the neodymium (III) nitrate salt present in the electrolyte composition at concentration of about 0.1 to 1 mol kg⁻¹ (molal). In some preferred embodiments, the neodymium (III) nitrate salt present in the electrolyte composition at concentration of about 0.15 to 0.75 moles kg⁻¹. Most preferably, at least one neodymium (III) nitrate salt or complex is present in the electrolyte at a concentration of up to and including 1 mol kg⁻¹ (1 molal) in the ionic liquid/electrolyte composition. In some embodiments, the neodymium (III) nitrate salt is present at a concentration of up to and including 0.75 mol kg⁻¹, 0.70 mol kg⁻¹, 0.65 mol kg⁻¹, 0.60 mol kg⁻¹, 0.55 mol kg⁻¹, 0.55 mol kg⁻¹, 0.50 mol kg⁻¹, 0.45 mol kg⁻¹, 0.40 mol kg⁻¹, 0.35 mol kg⁻¹, 0.30 mol kg⁻¹, 0.25 mol kg⁻¹, 0.20 mol kg⁻¹, 0.15 mol kg⁻¹, 0.10 mol kg⁻¹, or 0.05 mol kg⁻¹. In some preferred embodiments, the neodymium (III) nitrate salt present in N-butyl-N-methylpyrrolidinium dicyanamide ([C₄mpyr][DCA]) ionic liquid as electrolyte composition at concentration of about 0.2 to 0.5 moles kg⁻¹. In a preferred embodiment, the neodymium (III) salt is a neodymium (III) nitrate salt present in the electrolyte composition at concentration of about 0.5 moles kg⁻¹. In another embodiment, the neodymium (III) nitrate salt present in the electrolyte composition at concentration of about 0.2 moles kg⁻¹.

Preferably, the non-neodymium metal salt impurities are transition metal salts whereby the transition metal is preferably in the +2 and/or +3 oxidation state, more preferably the +2 oxidation state. In particular, the transition metal salts may have anions including oxyanions, halides, sulfate, nitrate, phosphate etc. Preferred impurity salts are one or more of at least one cobalt salt and/or at least one nickel salt, preferably a cobalt salt such a cobalt chloride.

Preferably, the electrodeposition involves the step of applying a potential to the substrate of −2.5 V or more positive vs Fc⁰/Fc⁺, of 2.0 V or more positive vs Fc⁰/Fc⁺, −1.7 V or more positive vs Fc⁰/Fc⁺, preferably of −1.5 V or more positive vs Fc⁰/Fc⁺, more preferably of −1.2 V or more positive vs Fc⁰/Fc⁺.

In some preferred embodiments, electrodeposition involves applying a potential to the conductive substrate of at least −1.7 V vs Fc⁰/Fc⁺. In other embodiments, reduction of the neodymium salt during the electrodeposition step occurs at −2.5 V vs Fc⁰/Fc⁺ or less, preferably at −2.0 V or less, more preferably at −1.75 V or less.

Suitably, the neodymium nitrate salt is an ionic salt of neodymium (III). In other embodiments, the neodymium salt is coordination complex/salt compound of neodymium nitrate. In some embodiments, the neodymium salt is in a crystalline form. In some embodiments, the neodymium salt includes water of hydration or crystallization, in other words a hydrated neodymium nitrate salt. Preferably, the neodymium in the salt is a Nd³⁺ oxidation state. Preferably, the neodymium salt is Nd(NO₃)₃·6H₂O. Where neodymium nitrate is used, e.g., Nd(NO₃)₃·6H₂O, it may be used at a starting concentration which is a saturation concentration for the particular ionic liquid being used. For example, the Nd nitrate salts may be at a concentration of from 0.05 moles kg⁻¹ to about 1 moles kg⁻¹, preferably 0.1 mol kg⁻¹ to about 0.75 mol kg⁻¹, more preferably from 0.2 mol kg⁻¹ to about 0.5 mol kg⁻¹. In a preferred embodiment involving N-butyl-N-methylpyrrolidinium dicyanamide ([C₄mpyr][DCA]) ionic liquid, the neodymium nitrate is used at a concentration of from about 0.2 mol kg⁻¹ to about 0.5 mol kg⁻¹ as this range, particularly 0.5 mol kg⁻¹, give high peak current densities and/or more positive onset of the reduction potentials of less than-2.0 V vs Fc⁰/Fc⁺.

More preferably, the ionic liquid does not comprise a halogenated anion. In some embodiments, the ionic liquid comprises a non-chlorinated anion. However, preferably, the ionic liquid comprises a non-fluorinated anion, more preferably does not comprise a fluorinated anion such as TFSI or triflate.

Preferably, each non-neodymium metal salt impurities may be dissolved in the ionic liquid as solvent at a concentration of up to the solubility limit of the particular impurity salt in the electrolyte composition in question. Preferably one or more of the impurities are present at a concentration of up to 40 wt % of the neodymium salt for each metal salt impurity present. In some embodiments, the solubility limit is up to and including 10 wt %, up to and including 15 wt %, up to and including 20 wt %, up to and including 25 wt % up to and including 30 wt %, up to and including 35 wt %, up to and including 40 wt % of the Nd salt concentration. In some embodiments, the concentration of impurities is of up to 35 wt %, up to 30 wt %, up to 25 wt %, up to 20 wt %, up to 15 wt %, up to 10 wt %, up to 9 wt %, up to 8 wt %, up to 7 wt %, up to 6 wt %, up to 5 wt %, up to 4 wt %, up to 3 wt %, up to 2 wt %, or up to 1 wt % of the Nd salt concentration. Preferably, the non-neodymium metal salt impurities dissolved in the ionic liquid as solvent at a concentration of up to 5 wt % of the neodymium salt for each metal salt impurity present. For example, in the case of CoCl₂·6H₂O, the solubility limit in N-butyl-N-methylpyrrolidinium dicyanamide ([C₄mpyr][DCA]) ionic liquid may be about 0.15 mol kg⁻¹, particularly in the case of a 0.5 mol kg⁻¹ Nd(NO₃)₃·6H₂O salt solution in N-butyl-N-methylpyrrolidinium dicyanamide ([C₄mpyr][DCA]) ionic liquid. In another example in the case of Ni(OTf)₂, the solubility limit in N-butyl-N-methylpyrrolidinium dicyanamide ([C₄mpyr][DCA]) ionic liquid may be 20 wt %, particularly in the case of 0.5 mol kg⁻¹ Nd(NO₃)₃·6H₂O salt solution in N-butyl-N-methylpyrrolidinium dicyanamide ([C₄mpyr][DCA]) ionic liquid.

Preferably, the method involves carrying out the electrodeposition at a temperature of less than 100° C. Desirably, the method involves carrying out the electrodeposition at a temperature of less than 90° C., less than 85° C., less than 80° C., less than 75° C., less than 70° C., less than 65° C., less than 60° C., less than 55° C., less than 50° C., less than 45° C., less than 40° C., less than 35° C., less than 30° C., less than 25° C., less than 20° C. The low operating temperatures make the Nd recovery process more sustainable and less energy intensive than existing recovery methods which use temperature well in excess of 100° C. and even up to 500° C. in the case of using molten salts.

In some embodiments, one or more of the non-neodymium metal salt impurities is present. It will be understood than more than a trace amount of at least one non-neodymium metal salt impurity is present. Desirably, the minimum concentration of each salt impurity present is at least about 0.1 wt %, preferably at least about 0.5 wt %, more preferably at least about 1 wt % of the Nd salt content. Therefore, preferably, before commencement of the electrodepositing step, the concentration of each non-neodymium salt impurity is at least about 0.1 wt % of the neodymium salt present in the electrolyte composition.

Preferably, water is present in the electrolyte composition at a concentration of up to and including: 14 wt %, 13 wt %, 12 wt %, 11 wt %, 10 wt %, 9 wt %, 8 wt %, 7 wt %, 6 wt %, 5 wt %, 4 wt %, 3 wt %, 2 wt %, 1 wt %, or 0.5 wt % of the ionic liquid/electrolyte composition. More preferably water is present up to and including 5 wt %, preferably up to and including up to 3 wt %, more preferably still up and including 2.5 wt % of the ionic liquid/electrolyte composition. It will be understood that at least trace amounts of water are present in the electrolyte composition of the invention. There is no requirement to remove water from the ionic liquid/electrolyte composition before carrying out the electrodepositing method.

In some embodiments, the electrodeposition step comprises reduction of the neodymium salt during the electrodeposition step at a reduction potential of −1.5 V vs Fc⁰/Fc⁺ or less, at least −1.4 V vs Fc⁰/Fc⁺ or less, at least −1.3 V vs Fc⁰/Fc⁺ or less, at least −1.2 V vs Fc⁰/Fc⁺ or less, at least −1.1 V vs Fc⁰/Fc⁺ or less. In some embodiments, the electrodeposition involves the step of applying a potential to the substrate of at least −1.2 V vs Fc⁰/Fc⁺, preferably at least −1.5 V vs Fc⁰/Fc⁺, more preferably at least −1.7 V vs Fc⁰/Fc⁺. In some embodiments, the reduction occurs at a reduction potential of −1.0 V vs Fc⁰/Fc⁺ or greater.

In some embodiments, the electrodeposition step comprises reduction of the neodymium salt during the electrodeposition step at an onset reduction potential of −2.5 V vs Fc⁰/Fc⁺ or less, −2.2 V vs Fc⁰/Fc⁺ or less, −2.1 V vs Fc⁰/Fc⁺ or less, −2.0 V vs Fc⁰/Fc⁺ or less, −1.9 V vs Fc⁰/Fc⁺ or less, −1.8 V vs Fc⁰/Fc⁺ or less, −1.7 V vs Fc⁰/Fc⁺ or less, −1.6 V vs Fc⁰/Fc⁺ or less, −1.5 V vs Fc⁰/Fc⁺ or less, −1.4 V vs Fc⁰/Fc⁺ or less, −1.3 V vs Fc⁰/Fc⁺ or less, −1.2 V vs Fc⁰/Fc⁺ or less, −1.1 V vs Fc⁰/Fc⁺ or less, or −1.0 V vs Fc⁰/Fc⁺ or less. In preferred embodiments, the reduction of the neodymium salt during the electrodeposition step occurs at −2.5 V vs Fc⁰/Fc⁺ or less, preferably at −2.0 V or less, more preferably at −1.75 V or less. It will be understood that the onset reduction potential corresponds to the intercept between the background current and the tangent of the reduction process.

In some embodiments, the reduction occurs at an onset reduction potential of at −0.75 V vs Fc⁰/Fc⁺ or greater.

Suitably, the conductive substrate is a metal substrate, for example, a nickel, copper, or platinum substrate. Nickel substrates are particularly preferred. The substrate can be in a foil, plate or rod form.

Preferably, the reduction involves the step of applying the potential to the substrate in the electrolyte composition which is used in a cell as electrolyte. In such embodiment, the conductive substrate can be configured as a working electrode provided in the electrolyte in a cell for carrying out the electrorecovery method.

Desirably, the method results in a neodymium recovery of 30% or greater, 35% or greater, is 40% or greater, is 45% or greater, is 50% or greater, is 60% or greater of the starting concentration of the Nd salt present in the electrolyte composition.

Preferably, the working electrode is a metal substate, such as a nickel substrate, a copper substrate, or a platinum substrate. Nickel substrates are particularly preferred.

Suitably, the electrodepositing step is carried out for a period of up to 1, 2, 3, 4, 5 or 6 hours (up to 6 hours), preferably about 3.5 hours. It will be understood that passing more current/charge through the system in general will speed up the time for reaching complete deposition of the recovered Nd.

In some embodiments, an electrochemical reaction involving reducing neodymium ion (from Nd salt) from a particular electrolyte composition of the invention including non-neodymium metal salt impurities onto a conductive substrate produces a peak cathodic current density of −40 mA cm⁻² or greater, −41 mA cm⁻² or greater, −42 mA cm⁻² or greater, −43 mA cm⁻² or greater, −44 mA cm⁻² or greater, −45 mA cm⁻² or greater, −46 mA cm⁻² or greater, −47 mA cm⁻² or greater, −48 mA cm⁻² or greater, −49 mA cm⁻² or greater, −50 mA cm⁻² or greater, −51 mA cm⁻² or greater, −52 mA cm⁻² or greater, −53 mA cm⁻² or greater, −54 mA cm⁻² or greater, −55 mA cm⁻² or greater, −56 mA cm⁻² or greater, −57 mA cm⁻² or greater, −58 mA cm⁻² or greater, −59 mA cm⁻² or greater, −60 mA cm⁻² or greater, for example as determined by cyclic voltammetry. Preferably the peak current cathodic current density can be determined by cyclic voltammetry, preferably at a scan rate of 100 mV s⁻¹, most preferably at 50° C. In some embodiments providing these current densities, the conductive substrate is nickel. In some embodiments providing these current densities, the metal salt impurity is a cobalt salt, preferably up to 40 wt % of the Nd salt, more preferably up to 20 wt % of the Nd salt. In the case of CoCl₂·6H₂O impurity at a concentration of 0.15 moles kg⁻¹, the peak current density is −60 mA cm⁻² or greater.

In some embodiment, the ionic liquid is a halogen free, more particularly, a fluorine free ionic liquid. An advantage that the electrodeposits of the invention are halide salt free, and in particular fluoride salt free, for example, free of NdX₃ (where X is halogen), and particularly NdF₃. Preferably, the non-halogenated anion of the ionic liquid, preferably the non-fluorinated anion, comprises at least one heteroatom with a lone pair having sufficient Lewis basicity for coordination to Nd³⁺. In a preferred embodiment, the non-halogenated anion of the ionic liquid comprises functional group that comprises a carbon joined to a nitrogen atom by a triple bond, e.g., a cyano group (—C═N) or cyanide group meaning the anion CN. In some embodiments, the anion comprises one or more cyanate groups (OCN—), one or more isocyanates (NCO—), one or more thiocyanate groups (SCN—), one or more isothiocyanate groups (NCS—), one or more cyanamide groups (where cyano is bonded to an amide group). In some embodiments, the anion may comprise a dicyanamide group (two cyanide groups bound to a central nitrogen atom, (NC)₂N), tricyanomethanide (TCM) anion (two cyanide groups bound to a central nitrogen atom, (NC)₃N) or tetracyanoborate (B(CN)₄). Suitably, the ionic liquid anion is dicyanamide or mesylate, either of which may be unsubstituted or substituted with one or more organic groups such as alkyls or ethers; halides; or heteroatom containing functional groups. In another embodiment, the non-halogenated anion of the ionic liquid comprises mesylate group.

Desirably, the ionic liquid comprises a non-halogenated anion (for example, any of the cyano group (—C═N) or cyanide group meaning the anion CN containing anions described above or mesylate) which may be alkyl substituted, dialkyl substituted, trialkyl substituted or quaternary alkyl substituted, preferably with one or more of: methyl, ethyl, propyl, butyl, pentyl, hexyl, heptyl, octyl, nonyl, decyl, undecyl, or dodecyl. One or more of the alkyl groups when present (or each alkyl group) may be straight/unbranched or branched, e.g., sec-butyl, or isobutyl, isopropyl, etc. One or more of the alkyl groups when present may comprise one or more heteroatoms (e.g., O, N, S but in particular O) in the chain in the place of one or more carbons in the alkyl backbone. One or more of the alkyl groups when present (or each alkyl group) may be alkoxylated with a C₁-C₆ alkoxide, preferably ethoxylated.

Desirably, the ionic liquid comprises a cation selected from a pyrrolidinium cation, a piperidinium cation, an imidazolium cation, a sulfonium cation, a phosphonium cation, guanidinium cation, or an ammonium cation, any one of which may be substituted or unsubstituted. Preferably, the ionic liquid comprises cation which is alkyl substituted, dialkyl substituted, trialkyl substituted or quaternary alkyl substituted, preferably with one or more of: methyl, ethyl, propyl, butyl, pentyl, hexyl, heptyl, octyl, nonyl, decyl, undecyl, or dodecyl. One or more of the alkyl groups when present (or each alkyl group) may be straight/unbranched or branched, e.g., sec-butyl, or isobutyl, isopropyl, etc. One or more of the alkyl groups when present may comprise one or more heteroatoms (e.g., O, N, S, but in particular, O) in the chain in the place of one or more carbons in the alkyl backbone. One or more of the alkyl groups when present (or each alkyl group) may be alkoxylated with a C₁-C₆ alkoxide, preferably ethoxylated.

Desirably, the ionic liquid is selected from the group consisting of: pyrrolidinium dicyanamide, a piperidinium dicyanamide, an imidazolium dicyanamide, a sulfonium dicyanamide, a phosphonium dicyanamide or an ammonium dicyanamide. Preferably, the ionic liquid is a pyrrolidinium dicyanamide, in particular, a dialkyl substituted pyrrolidinium dicyanamide. Desirably, the ionic liquid is N-butyl-N-methylpyrrolidinium dicyanamide ([C₄mpyr][DCA]).

Preferably, the cobalt salt impurity and/or the nickel salt impurity comprises the metal in the +2 oxidation state and/or the +3 oxidation state. The salt anion may be chloride, oxide, triflate, nitrate, sulfate, etc. Cobalt salt impurities including cobalt (II) salt impurities, such as cobalt chloride are particularly preferred since they give excellent current densities and particularly low onset reduction potentials, e.g., −1.6 V vs Fc⁰/Fc⁺ in the case of 0.5 m Nd(NO₃)₃·6H₂O.

Desirably, the cobalt salt impurity is CoCl₂·6H₂O. Preferably, the cobalt salt impurity, preferably CoCl₂·6H₂O, is present at a concentration of up to about 0.15 mol kg⁻¹. Thus, in some embodiments the cobalt salt impurity, preferably CoCl₂·6H₂O, is present at a concentration of up to about 20% of the Nd content based on mol/kg. In some embodiments the cobalt salt impurity, preferably CoCl₂·6H₂O, is present at a concentration of up to about 3 wt % of the electrolyte composition.

Suitably, the nickel salt impurity is Ni(OTf)₂. Desirably, the nickel salt impurity, preferably Ni(OTf)₂, is present at a concentration of up to 0.1 mol kg⁻¹. Thus, in some embodiments the nickel salt impurity, preferably Ni(OTf)₂., is present at a concentration of up to about 30% of the Nd content based on mol/kg. In some embodiments the nickel salt impurity, preferably Ni(OTf)₂, is present at a concentration of up to about 3 wt % of the electrolyte composition.

In one embodiment, the electrolyte comprises 0.1 mol/kg (molal) Nd(NO₃)₃·6H₂O in N-butyl-N-methylpyrrolidinium dicyanamide ([C₄mpyr][DCA]).

In one embodiment, the electrolyte composition comprises Nd(NO₃)₃·6H₂O and CoCl₂·6H₂O, preferably in N-butyl-N-methylpyrrolidinium dicyanamide ([C₄mpyr][DCA]), preferably where Ni(OTf)₂, is present at a concentration of up to 0.1 mol kg⁻¹.

In one embodiment, the electrolyte composition comprises Nd(NO₃)₃·6H₂O and Ni(OTf)₂, preferably in N-butyl-N-methylpyrrolidinium dicyanamide ([Campyr][DCA]), preferably where CoCl₂·6H₂O, is present at a concentration of up to about 0.15 mol kg⁻¹.

In one embodiment, the electrolyte composition comprises 0.5 mol/kg Nd(NO₃)₃·6H₂O and 0.15 mol/kg CoCl₂·6H₂O in N-butyl-N-methylpyrrolidinium dicyanamide ([C₄mpyr][DCA]).

In one embodiment, the electrolyte composition comprises 0.5 mol/kg Nd(NO₃)₃·6H₂O and 0.1 mol/kg Ni(OTf)₂ in N-butyl-N-methylpyrrolidinium dicyanamide ([C₄mpyr][DCA]).

Preferably, the recovered electrodeposit comprises greater than a 1:1 ratio, greater than a 1.25:1 ratio, greater than a 1.5:1 ratio of neodymium metal (Nd⁰) and neodymium oxide (Nd₂O₃) in favour of greater neodymium metal (Nd⁰) content. In some embodiments, the recovered electrodeposit comprises a ratio of between 1:1 and 1:0.3 of neodymium metal (Nd⁰) and neodymium oxide (Nd₂O₃). In some embodiments, the recovered electrodeposit comprises a ratio of between 1:0.75 and 1:0.30 of neodymium metal (Nd⁰) and neodymium oxide (Nd₂O₃). In some embodiments, the recovered electrodeposit comprises a ratio of between 1:0.67 and 1:0.30 of neodymium metal (Nd⁰) and neodymium oxide (Nd₂O₃). In some embodiments, the recovered electrodeposit comprises a ratio of between 1:0.65 and 1:0.30 of neodymium metal (Nd⁰) and neodymium oxide (Nd₂O₃). In some embodiments, the recovered electrodeposit comprises a ratio of between 1:0.60 and 1:0.30 of neodymium metal (Nd⁰) and neodymium oxide (Nd₂O₃).

Suitably in some embodiments, the electrodeposit formed comprises a ratio of neodymium metal (Nd⁰) to neodymium oxide (Nd₂O₃) which is 1:0.45 or better, 1:0.4 or better, 1:0.35 or better, 1:0.30 or better, 1:0.25 or better, 1:0.20 or better, in favour of greater neodymium metal (Nd⁰) in the electrodeposit. Preferred methods for determining the ratio are described above. Suitably, the neodymium nitrate salt and the transition metal salts solutions are derived from recycling/recovery processing of end-of-life products, such as permanent magnets or batteries. Typically, this will involve leaching the salts from the products, typically with strong acid, thereby generating one or more of salts such as oxides, nitrates, and sulfates.

The invention extends to an electrolyte composition for neodymium electrodeposition by electrochemical reduction of neodymium onto a conductive substrate at a temperature of less than 100° C. The composition of the invention may be used in the method of the invention and comprises: an ionic liquid comprising a non-halogenated anion, preferably a non-fluorinated anion; at least one neodymium (III) nitrate salt in a concentration at a saturation concentration for the electrolyte, water at a concentration of up to and including 15 wt % of the composition, and one or more non-neodymium metal salt impurities selected from transition metal salt impurities, dissolved in the electrolyte composition as solvent, the impurities at a concentration of up to 40 wt % of the neodymium salt for each metal salt impurity present.

The features described above in respect of the components of the method equally apply to the electrolyte composition aspect of the invention.

The invention further pertains to recovered neodymium in the form of one or more of neodymium metal (Nd⁰) and neodymium oxide (Nd₂O₃) obtainable or obtained by the method by the method of the first aspect. Suitably, the recovered neodymium is free of halogenated neodymium salt, more preferably free of fluorinated neodymium salt, preferably, NdF₃ free.

The invention extends to electrochemically recovered neodymium as described in the context of the invention for use in applications such as energy generation, transportation, and electronic device applications. Desirably such applications include a permanent magnet for example in mobile phones, hard disk drives, wind turbines and electric motors in automobiles or in an alloy anode material for a nickel-metal hydride batteries, for example, that fuel hybrid vehicles.

### Experimental

Experiments were carried out for a model electrorecovery system using an electrolyte composition without non-Nd salt impurities initially and then repeated using a more real-life system whereby the electrolyte composition used also includes one or more metal salts impurities. While positive results in terms of Nd recovery from the salt/IL electrolyte solution were obtained with the model system absent impurities, most unexpectedly, the electrodeposition using the Nd salt/IL electrolyte with Co or Ni metal salt impurities gave the best results in terms of less negative reduction potentials, highest cathodic reduction potentials, as well as control of the ratio of Nd: Nd₂O₃ in the electrodeposits, e.g., to favour a higher ratio of Nd metal in the electrodeposit.

### Example 1—Nd Recovery in a Model Electrolyte System without Impurities (PERIYAPPERUMA, K. Et al.)

### Materials and Electrolytes—Example 1—Model Electrolyte System without Impurities

N-Butyl-N-methylpyrrolidinium dicyanamide ([C₄mpyr][DCA]) IL was purchased from Solvionic (99.9%) and triethyl(methyl)phosphonium bis(fluorosulfonyl)imide ([P₁₂₂₂][FSI]) from Boron Molecular, Australia. Neodymium trifluoromethanesulfonate (Nd(OTf)₃, TCI, 97.0%) and neodymium nitrate hexahydrate (Nd(NO₃)₃·6H₂O, ThermoFischer, 99.9%) salts were used as received to prepare the electrolyte solutions. A maximum (saturation) concentration of: 0.2 mol kg⁻¹ (molal, m) of Nd(OTf)₃ and 0.5 mol kg⁻¹ (m) of Nd(NO₃)₃·6H₂O were achieved in [C₄mpyr][DCA] IL at 50° C. For comparison purposes 0.2 mol kg⁻¹ (m) Nd(NO₃)₃·6H₂O was also prepared. In [P₁₂₂₂][FSI] IL, only Nd(NO₃)₃·6H₂O was soluble and the maximum (saturation) concentration achieved was 0.1 mol kg⁻¹. The water content of the electrolyte solutions was determined by Karl-Fischer (Metrohm, Switzerland) titration and reported in Table 1.

### Electrochemical Measurements—Example 1—Model Electrolyte System without Impurities

The cyclic voltammetry (CV) and chronoamperometric Nd electrodeposition measurements were performed on a VMP 3 multichannel potentiostat (Bio-Logic, USA) connected to an Ar-filled glovebox (H₂O and O₂<0.1 ppm). The electrochemical experiments were performed in a three-electrode cell configuration using a 1.5 mm diameter Ni metal or 1 mm diameter glassy carbon (GC) working electrode (WE, ALS Co. Ltd, Japan), a Pt wire or Nd rod counter electrode (CE, 3 mm diameter, Goodfellow Cambridge Ltd, England) and an Ag/Ag⁺ reference electrode (RE, eDAQ Pty Ltd, Australia). The RE electrode was prepared by immersing a Ag wire in 5 mM silver triflate (AgOTf) in [C₄mpyr][DCA] or [P₁₂₂₂][FSI]ILs. The redox potential of Fc⁰/Fc⁺ was +0.54 and −0.35 V vs. Ag/Ag⁺ for [C₄mpyr][DCA] and [P₁₂₂₂][FSI] reference electrodes, respectively. All the potentials in this work are reported vs. Fc⁰/Fc⁺. Prior to CV measurements, the WE was polished with 0.3 μm alumina powder and sonicated with deionized water followed by drying at 70° C. for 1 hour. All the experiments in this study were performed in a standard electrochemical cell at 50° C. in an Ar-filled glovebox (H₂O and O₂<0.1 ppm). A temperature of 50° C. was used to compensate for the increase in electrolyte viscosity by the addition of Nd salt to the ILs. An electrolyte volume of 1 ml was used for each experiment.

### Dynamic Viscosity—Example 1

The dynamic viscosity of the electrolyte solutions was measured with an Anton Paar Lovis (Austria) 2000ME microviscometer using the rolling ball method at 50° C. The electrolytes were placed in a capillary diameter of 1.8 mm and an angle of 30° was set for all the measurements. The dynamic viscosity was calculated using the density of the electrolyte, which was measured with an Anton Paar DMA4500 densimeter at 50° C.

### Surface Characterisation (SEM, EDX Mapping and XPS)—Example 1—Model Electrolyte System without Impurities

Scanning electron microscopy (SEM) and energy dispersive X-ray spectroscopy (EDX). The samples were prepared by electrodepositing Nd onto a masked Ni foil (99.99%, Alfa-Aesar) with a 3 mm diameter exposed area for 3.5 hours. The potentials at which the electrodeposits were made are −2.94, −2.24 and −1.84 V vs. Fc^{0/+} for 0.2 m Nd(OTf)₃/[C₄mpyr][DCA], 0.5 m Nd(NO₃)₃·6H₂O/[C₄mpyr][DCA] and 0.1 m Nd(NO₃)₃·6H₂O/[P₁₂₂₂][FSI], respectively.

The potentials are also mentioned at corresponding Figure captions. Prior to electrodeposition, Ni foil was etched with diluted HCl acid (1 M) followed by sonication for 2 minutes in deionized H₂O and isopropanol to clean the surfaces. The foils were then dried at 100° C. overnight under vacuum. The electrodeposits were rinsed with anhydrous THF (<40 ppm H₂O, ≥99.9%, Sigma-Aldrich) and dried under vacuum to completely remove the solvent prior to mounting the samples in an air-sensitive SEM sample holder under Ar atmosphere. All the SEM measurements were taken on a JSM-IT300 SEM (JOEL Ltd, Japan) equipped with an Oxford X-Max 50 mm² silicone drift detector at an acceleration voltage of 5 kV and 30 pA probe current. EDX mapping was performed at an acceleration voltage of 15 kV and at high current mode for 30 minutes.

### X-Ray Photoelectron Spectroscopy (XPS)—Example 1

The Nd samples were prepared following the same method as the SEM samples. XPS was performed on a Thermo Scientific Nexsa spectrometer (Czech Republic) equipped with a hemispherical analyzer. The incident radiation was monochromatic Al Ka X-rays (1486.6 eV) at 72 W (6 mA and 12 kV, 250 μm spot).

Survey (wide) and high-resolution (narrow) scans were recorded at analyzer pass energies of 150 and 50 eV, respectively. Survey scans were performed with a step size of 1.0 eV and a dwell time of 10 ms. High-resolution scans were obtained with a step size of 0.1 eV and dwell time of 50 ms.

The base pressure in the analysis chamber was less than 5.0×10⁻⁹ mbar. A low-energy dual-beam (ion and electron) flood gun was used to compensate for surface charging. The samples were etched using cluster mode. All data were processed using CasaXPS software (version 2.3.22PR1.0) and the energy calibration was referenced to the low binding energy component of the C 1s peak at 284.8 eV.

### Inductively Coupled Plasma Mass Spectroscopy (ICP-MS)—Example 1—Model Electrolyte System without Impurities

The electrodeposit samples were prepared following a similar method to SEM samples using 0.2 m Nd(OTf)₃ and 0.5 m Nd(NO₃)₃·6H₂O in [C₄mpyr][DCA] IL electrolytes. The electrodeposits (with the Ni substrate) were first dissolved in 2 ml of conc. HNO₃ acid (70%) followed by centrifuging at 2000 RCF (relative centrifugal force) for 30 s at room temperature. The solutions were then heated at 70° C. in a water bath for 1 hour until complete dissolution of the deposits occurred and then cooled down to room temperature prior to analysis. The ICP-MS measurement for Nd³⁺ was performed on a PerkinElmer NexION 350X using Syngistix™ (PelkinElmer; Waltham, MA, USA) software. The Nd recovery efficiency was calculated by the ratio between the mass recovered and the theoretical mass deposited assuming the deposited species is only Nd metal.

### Results and Discussion—Example 1—Model Electrolyte System without Impurities

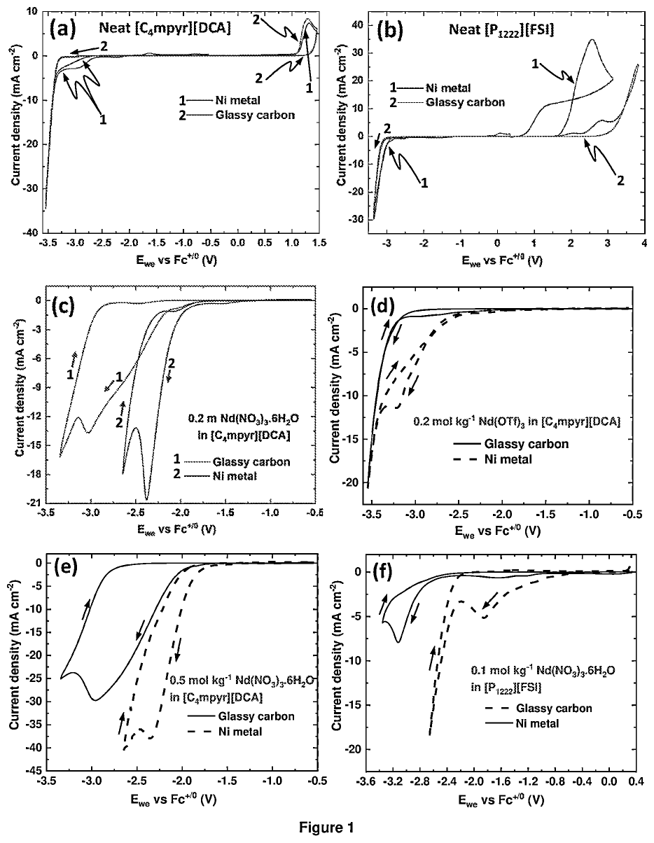

FIG. 1 compares the electrochemical behaviour of Nd(OTf)₃ and Nd(NO₃)₃·6H₂O salts in [C₄mpyr][DCA] and [P₁₂₂₂][FSI] IL electrolytes using a glassy carbon (GC) substrate at 50° C. In this study, as the subsequent electrodeposition was performed on a Ni working electrode, the Nd³⁺ electrochemical behaviour was also studied using a Ni metal substrate for more accurate interpretation of the data. The electrochemical windows of the neat ILs are shown in FIG. 1(a) and(b). The onset reduction potential (intercept between the background current and the tangent of the reduction process) for [C₄mpyr][DCA] IL was −3.25 V vs. Fc^{0/+}. However, an additional small reduction peak was also present at −2.70 V on the Ni substrate indicating a side reaction possibly from impurities present on the Ni surface followed by an oxidation peak at −1.5 V during the reversed scan. The [P₁₂₂₂][FSI] IL showed non-faradaic current until −3 V on both GC and Ni substrates.

As shown in FIG. 1(c-f), in all the electrolyte systems with neodymium salt, a lower onset Nd³⁺ reduction potential was evident on the Ni substrate compared to that of GC.

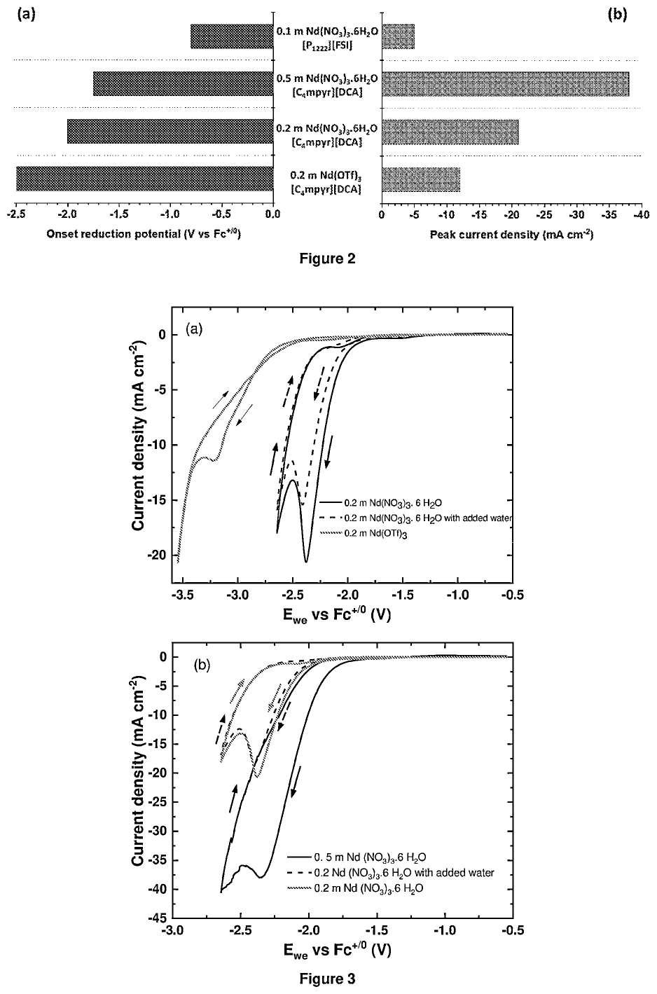

The electrochemical behaviour of Nd³⁺ on a Ni working electrode is discussed further below. When considering the electrochemical performance on GC, the 0.2 m Nd(OTf)₃ in [C₄mpyr][DCA] did not show a clear Nd³⁺ reduction peak prior to electrolyte decomposition at −3.25 V. However, both the 0.2 m and 0.5 m Nd(NO₃)₃·6H₂O in [C₄mpyr][DCA] on GC showed a distinct reduction peak prior to electrolyte decomposition. However, the voltage profiles on GC are broader compared to that on the Ni substrate. Further, the less concentrated system showed a shoulder on the voltage curve at −2.5 V. FIG. 2 presents the onset reduction potential and peak current densities obtained from the above electrolyte systems on the Ni substrate. As shown in FIG. 2(a), the phosphonium system resulted in a more positive reduction potential (onset and peak potentials: −0.80 and −1.85 V). Based on the redox potentials reported for Nd³⁺ reduction in other kinds of phosphonium ILs (onset and peak potentials: −2.0 and −2.5 V vs. Fc^{0/+}, respectively), such less negative values are unlikely to originate from Nd³⁺deposition but side reactions (e.g. due to residual H₂O). A more negative onset potential of −2.50 V (peak potential −3.20 V) was observed in 0.2 m Nd(OTf)₃/[C₄mpyr][DCA] electrolyte system, whereas both 0.2 and 0.5 m Nd(NO₃)₃·6H₂O/[C₄mpyr][DCA] electrolytes showed relatively positive reduction potentials (onset: −2.00 and −1.75 V, peak potentials: −2.34 and −2.38 V). When comparing the similar concentration (0.2 m)triflate and nitrate electrolyte systems, the latter showed a 0.5 V more positive reduction potential, indicating an easier Nd³⁺ reduction. This difference could be in part due to their distinct mass transport properties influenced by different H₂O concentrations affecting the fluidity of the electrolytes (31 vs. 21 mPa s) and/or altering Nd³⁺ speciation.

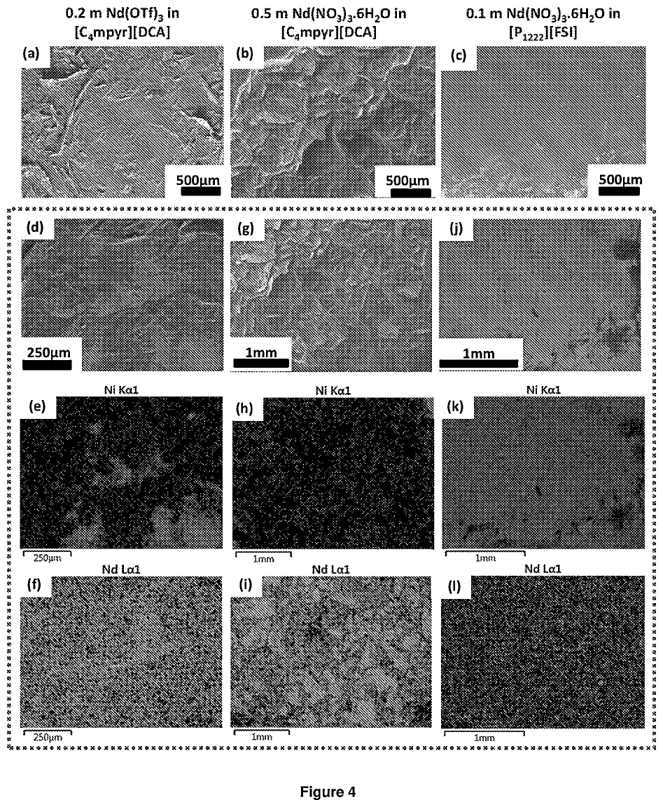

This will be discussed in detail later (Table 1 and FIG. 3). When considering the Nd(NO₃)₃·6H₂O/[C₄mpyr][DCA] system, surprisingly the highly concentrated electrolyte (0.5 m) showed a more positive onset reduction potential compared to the equivalent 0.2 m system. Further, as shown in FIG. 2(b), with increasing Nd(NO₃)₃·6H₂O concentration from 0.2 to 0.5 m, the peak current density increased simultaneously indicating the peak is due to Nd³⁺ reduction according to the Randles-Sevcik equation. Among all the electrolyte model systems analysed (without impurities), the 0.5 m Nd(NO₃)₃·6H₂O/[C₄mpyr][DCA] system resulted in the highest peak current density (ca. −40 mA cm⁻²). The highest peak current densities obtained in the present study is at least eight times higher than values reported in the literature at similar or even higher temperatures, exemplifying a more efficient electrolyte composition for Nd recovery by electrodeposition.

As previously mentioned, all the model electrolytes in this study were used without drying to mimic the realistic conditions at which REM recovery may occur. Therefore, the water contents in the 0.2 m Nd(OTf)₃, 0.2 and 0.5 m Nd(NO₃)₃·6H₂O in [C₄mpyr][DCA] IL electrolyte systems are different (Table 1). As this can lead to distinct mass transport properties affecting Nd³⁺ ion diffusion and thus the recovery potentials and peak current densities, further investigations were performed to analyse the effect of water content in the electrolytes. As shown in Table 1, despite the same Nd³⁺ concentration, 0.2 m Nd(OTf)₃ system resulted a relatively higher onset potential and lower peak current density than 0.2 m Nd(NO₃)₃·6H₂O. As this could be directly related to different water contents in the electrolytes (0.15 vs. 2.4 wt %), water was added to the 0.2 m Nd(OTf)₃ system to make it comparable with the nitrate electrolyte.

As shown in FIG. 3(a), the addition of water resulted in relatively similar onset reduction potentials for both electrolyte systems and an increase in the peak current density for the triflate system which can be attributed to the decrease in viscosity from 31 to 26 mPa s facilitating the mass transport properties.

However, the nitrate system still showed a higher peak current density, which possibly may be due to more favourable mass transport properties compared to the triflate system. When comparing the 0.2 and 0.5 m Nd(NO₃)₃·6H₂O systems, approximately twice the water content was evident in the more concentrated electrolyte. The addition of water to the less concentrated electrolyte did not cause any changes in the viscosity. Further, the onset reduction potential and the peak current densities were also unaffected (FIG. 3b).

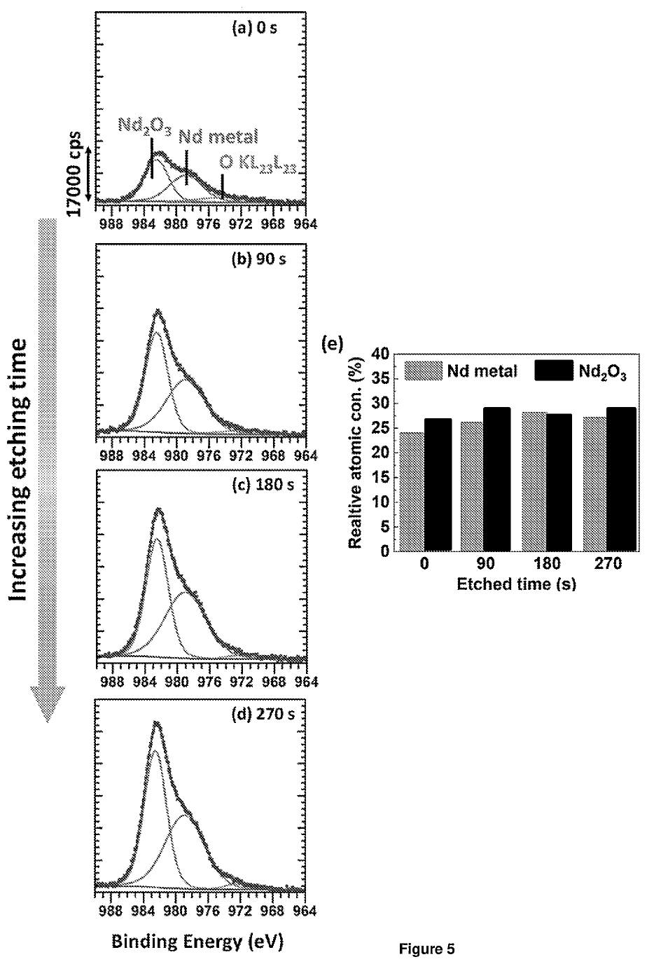

FIG. 4 presents a comparative analysis of the electrodeposits resulting from the most concentrated electrolytes used in this study: 0.1 m Nd(NO₃)₃·6H₂O in [P₁₂₂₂][FSI], 0.2 m Nd(OTf)₃ and 0.5 m Nd(NO₃)₃·6H₂O in [C₄mpyr][DCA]. The potentials at which the electrodeposits were grown (reported in FIG. 4) were chosen based on their electrochemical behaviour on the Ni substrate, as shown in FIG. 1. The electrodeposit formed from the Nd(OTf)₃/[C₄mpyr][DCA] system (FIG. 4a) was thin and showed a film-like morphology. In comparison, a thicker and flaky deposit was formed from the Nd(NO₃)₃·6H₂O/[C₄mpyr][DCA] electrolyte (FIG. 4b). The difference in the amount of material deposited can be attributed to the higher charge passed by the more concentrated Nd(NO₃)₃·6H₂O system compared to that of Nd(OTf)₃ during the Nd³⁺ reduction process (0.17 vs. 0.54 mA h). The EDX mapping showed a uniform distribution of Nd in both electrodeposits from the [DCA]-electrolyte systems (FIGS. 4f and i). However, when comparing the elemental map for Ni (from substrate) (FIGS. 4e and h), the deposit from Nd(NO₃)₃·6H₂O/[C₄mpyr][DCA] showed a better coverage compared to that from the Nd(OTf)₃/[C₄mpyr][DCA] system.

Based on the ICP analysis (Table 2), two times higher Nd recovery or current efficiency (60%) was obtained for the electrodeposit resulting from the nitrate electrolyte compared to that of the triflate system (35%).

TABLE 2
Summary of the theoretical yield and Nd recovery
efficiencies (current efficiency) from 0.2 m
Nd(OTf)₃ and 0.5 m Nd(NO₃)₃•6H₂O
in [C₄mpyr][DCA] electrolytes at 50° C.
(Nd³⁺ reduction time duration = 3.5 hours).

| | | | | Theoretically | |
|---|---|---|---|---|---|
| | | Nd⁰ | Nd³⁺ | recovered | |
| | | Theo- | in 1 ml | Nd from | Current |
| | Charge | ret- | of electro- | 1 ml of | effi- |
| | passed | ical | lyte | electrolyte | ciency |
| Electrolyte | (mAh) | (mg) | (mg) | (%) | (%) |
| 0.2 m Nd(OTf)₃ | 0.153 | 0.27 | 28.8 | 0.9% | 35 |
| 0.5 m | 0.225 | 0.40 | 72.1 | 0.6% | 60 |
| Nd(NO₃)₃•6H₂O | | | | | |

[Theoretically recovered Nd from 1 ml of electrolyte = Theoretically deposited Nd⁰/Nd³⁺ in 1 ml of electrolyte]

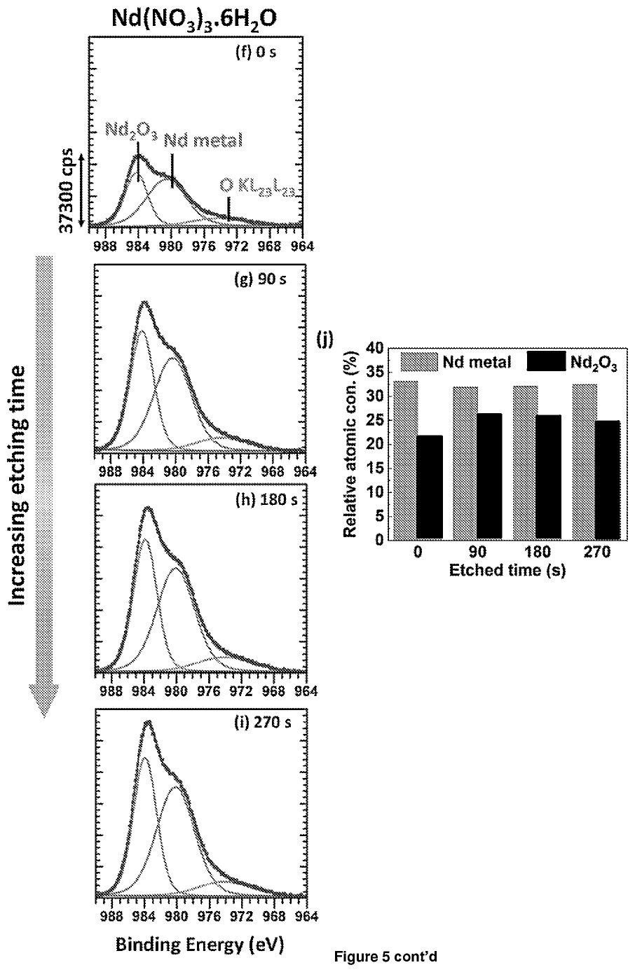

The lower recovery efficiency of the 0.2 m Nd(OTf)₃ can be attributed to simultaneous IL decomposition (at below −2.7 V) with its more negative Nd³⁺ reduction potential (−2.94 V). Therefore, overall, the nitrate system appears to be the more promising candidate for Nd recovery. However, Nd(NO₃)₃·6H₂O/[P₁₂₂₂][FSI] (FIG. 1f) did not show any evidence for an electrodeposit formation (FIG. 4c). In agreement with the SEM images, EDX analysis also showed a high concentration of elemental Ni compared to other samples (FIG. 4e, h) and Nd₂O₃. Therefore, the electrodeposits resulting from 0.2 m Nd(OTf)₃ and 0.5 m Nd(NO₃)₃·6H₂O in [C₄mpyr] [DCA] IL electrolytes were further analysed using XPS surface and depth profiling to investigate the changes in the deposit composition in the inner layers of the electrodeposits. The Nd 3d_{5/2} spectra analysed for both samples at various depths are shown in FIG. 5. Both surfaces showed evidence for the presence of Nd metal (979-980 eV) and Nd₂O₃ (>982 eV). The 3rd component present in the spectra was attributed to the O KL₂₃L₂₃ auger electron line. As the etching progressed from the top surface (i.e. at 0 s) to inner layers (i.e. at 90 s or higher), both samples showed an increase in Nd 3d_{5/2} peak intensity, indicating an enhanced amount of the species present. The relative atomic concentrations of Nd metal and Nd₂O₃ determined from the Nd 3d_{5/2} region spectra at each depth for both samples are summarised in FIG. 5(e) and(j). The electrodeposit resulting from the 0.2 m Nd(OTf): system showed an approximately 1:1 ratio between Nd metal and Nd₂O₃, whereas a slightly higher Nd metal content (Nd metal: Nd₂O₃, 1.5:1) was obtained for the deposit from the 0.5 m Nd(NO₃)₃·6H₂O system. However, the presence of Nd₂O₃ throughout the analysed sample depth of both electrodeposits suggests that it is being produced by an electrochemical reaction during Nd³⁺ reduction. We hypothesize that this is due to the presence of H₂O in the electrolyte solutions as they were used without drying to mimic realistic metal recovery conditions.

For instance, Matsumiya et al. demonstrated that by changing the Nd³⁺ reduction potential from −3.4 V to −3.6 V vs. Ag/Ag⁺ in [DEME][TFSI] IL electrolyte (DEME=diethylmethyl (2-methoxyethyl) ammonium), the electrodeposit composition can be changed from a Nd metal rich phase to a Nd₂O₃ dominant composition. Therefore, following similar approaches, the composition of the electrodeposits resulting from the current study could be further modified to achieve Nd metal or Nd₂O₃ rich composition if required. The amount of material deposited could also be increased by introducing stirring condition to enhance the mass transport properties and/or implementing other electrolysis techniques such as potential or galvanic pulsed electrodeposition. Nevertheless, both the Nd metal or Nd₂O₃ materials are considered highly valuable due to their many applications ranging from permanent magnets to safety glazing material for automobiles.

### Conclusions—Example 1—Model Electrolyte System without Impurities

Successful recovery of neodymium via electrodeposition using Nd(OTf)₃ or Nd(NO₃)₃·6H₂O salts in the low cost, non-fluorinated [Campyr][DCA] IL has been achieved. In contrast, the [FSI]-based IL, [P₁₂₂₂][FSI], was not able to support the electrochemical reduction of Nd³⁺ and produce an electrodeposit.

Of the [DCA]-based electrolytes examined in the model electrolyte system, the highest concentration 0.5 m Nd(NO₃)₃·6H₂O system showed superior electrochemical behaviour and electrodeposit properties including easier Nd³⁺ reduction (−1.75 V), higher current density (−38 mA cm⁻²), and a more uniform and thicker deposit with better coverage. It is believed that this may be a result of the formation of distinct Nd³⁺ solvation complexes, with different numbers/types of H₂O, [DCA]- and [NO₃]-ligands coordinated to Nd³⁺ compared to the less concentrated 0.2 m Nd(OTf)₃ and 0.2 m Nd(NO₃)₃·6H₂O electrolytes. The electrodeposits resulting from both [DCA]-electrolytes showed evidence for the presence of Nd₂O₃ throughout the sample depth, suggesting it was produced as part of the electrochemical reduction process. This was attributed to the presence of water in the electrolyte mixtures which has typically, previously been avoided.

Further unexpectedly, among the two electrodeposits, the one from the Nd(NO₃)₃·6H₂O/[C₄mpyr][DCA] system (nitrate system) showed a higher Nd metal content compared to Nd₂O₃ (1.5:1) and a higher Nd recovery efficiency (60% for nitrate system vs. 35% for the OTf system). These electrolytes were able to recover neodymium under comparatively mild (i.e., lower temperature) and less controlled (i.e., moisture content) experimental conditions. This suggests their potential applicability in establishing more sustainable recovery methods for Nd in the form of either Nd metal and/or Nd₂O₃ where both materials are considered highly valuable in the current REM market.

### Example 2—Nd Electrodeposition in the Present of Impurities Materials and Electrolytes—Example 2

N-Butyl-N-methylpyrrolidinium dicyanamide ([C₄mpyr][DCA]) IL was purchased from Solvionic (99.9%). Neodymium nitrate hexahydrate (Nd(NO₃)₃·6H₂O, ThermoFischer, 99.9%), CoCl₂·6H₂O (Sigma-Aldrich, 99.9%) and Ni(OTf)₂ (Sigma-Aldrich, 99.9%) salts were used as received to prepare the electrolyte solutions. Two solutions containing 0.5 mol kg⁻¹ Nd(NO₃)₃·6H₂O in [C₄mpyr][DCA] with either 0.15 mol kg⁻¹ CoCl₂·6H₂O or 0.1 mol kg⁻¹ Ni(OTf)₂ (0.2192 g Nd(NO₃)₃·6H₂O added in 1.0000 g [C₄mpyr][DCA] and subsequently added 0.0357 g of CoCl₂·6H₂O or Ni(OTf)₂) were prepared at 50° C. after stirring for 12 hours. The solutions were prepared and stored in argon filled glovebox (Korea Kiyon, with nominal levels of oxygen and water less than 1 ppm). The water content of the electrolyte solutions was determined by Karl-Fischer (Metrohm, Switzerland) titration.

### Electrochemical Measurements—Example 2—Nd Electrodeposition in the Present of Impurities

The cyclic voltammetry (CV) and chronoamperometric Nd electrodeposition measurements were performed on a VMP 3 multichannel potentiostat (Bio-Logic, USA) connected to an Ar-filled glovebox (H₂O and O₂<0.1 ppm). The electrochemical experiments were performed in a three-electrode cell configuration using a 1.5 mm diameter Ni metal working electrode (WE, ALS Co. Ltd, Japan), a Nd rod counter electrode (CE, 3 mm diameter, Goodfellow Cambridge Ltd, England) and a Ag/Ag⁺ reference electrode (RE, eDAQ Pty Ltd., Australia). The RE electrode was prepared by immersing a Ag wire in 5 mM silver triflate (AgOTf) in [C₄mpyr][DCA]. The redox potential of Fc⁰/Fc⁺ was +0.55 V vs Ag/Ag⁺ for [Campyr][DCA] reference electrodes, respectively. All the potentials in this work are reported vs Fc⁰/Fc⁺. Prior to CV measurements the WE was polished with 0.3 μm alumina powder and sonicated with deionized water followed by drying at 70° C. for 1 hour. All the experiments in this study were performed in a standard electrochemical cell at 50° C. in an Ar-filled glovebox to control the O₂ content. A temperature of 50° C. was used to compensate for the increase in electrolyte viscosity by the addition of Nd salt to the ILs. An electrolyte volume of 1 ml was used for each experiment.

### Surface Characterisation (SEM, EDX Mapping and XPS)—Example 2—Nd Electrodeposition in the Present of Impurities

Scanning Electron Microscopy (SEM) and Energy Dispersive X-ray Spectroscopy (EDX)—The samples were prepared by electrodepositing Nd onto a masked Ni foil (99.99%, Alfa-Aesar) with a 3 mm diameter exposed area for 3.5 hours at 50° C. The potentials at which the electrodeposits were made are −2.24 V, −2.15 V and −2.25 V vs Fc^{0/+} for 0.5 mol kg⁻¹ Nd(NO₃)₃·6H₂O in [Campyr][DCA] IL electrolyte, 0.5 mol kg⁻¹ Nd(NO₃)₃·6H₂O+0.15 mol kg⁻¹ CoCl₂·6H₂O in [C₄mpyr][DCA] IL electrolyte and 0.5 mol kg⁻¹ Nd(NO₃)₃·6H₂O+0.1 mol kg⁻¹ Ni(OTf)₂ in [C₄mpyr][DCA] IL electrolyte, respectively. The potentials are also mentioned at corresponding Figure captions. Prior to electrodeposition, Ni foil was etched with diluted HCl acid (1 M) followed by sonication for 2 minutes in deionized H₂O and isopropanol to clean the surfaces. The foils were then dried at 100° C. overnight under vacuum. The electrodeposits were rinsed with anhydrous THF (<40 ppm H₂O, ≥99.9%, Sigma-Aldrich) and dried under vacuum to completely remove the solvent prior to mounting the samples in an air-sensitive SEM sample holder under Ar atmosphere. All the SEM measurements were taken on a JSM-IT300 SEM (JOEL Ltd., Japan) equipped with an Oxford X-Max 50 mm² silicone drift detector at an acceleration voltage of 5 kV and 30 pA probe current. EDX mapping was performed at an acceleration voltage of 15 kV and at high current mode for 30 minutes.

X-ray Photoelectron Spectroscopy (XPS)—The Nd samples were prepared following the same method as the SEM samples. XPS was performed on a Thermo Scientific Nexsa spectrometer (Czech Republic) equipped with a hemispherical analyzer. The incident radiation was monochromatic Al Ka X-rays (1486.6 eV) at 72 W (6 mA and 12 kV, 250 μm spot). Survey (wide) and high-resolution (narrow) scans were recorded at analyzer pass energies of 150 and 50 eV, respectively. Survey scans were performed with a step size of 1.0 eV and a dwell time of 10 ms. High-resolution scans were obtained with a step size of 0.1 eV and dwell time of 50 ms. The base pressure in the analysis chamber was less than 5.0×10⁹ mbar. A low-energy dual-beam (ion and electron) flood gun was used to compensate for surface charging. The samples were etched using cluster mode. All data were processed using CasaXPS software (version 2.3.22PR1.0) and the energy calibration was referenced to the low binding energy component of the C 1 s peak at 284.8 eV.

### Results and Discussion—Example 2

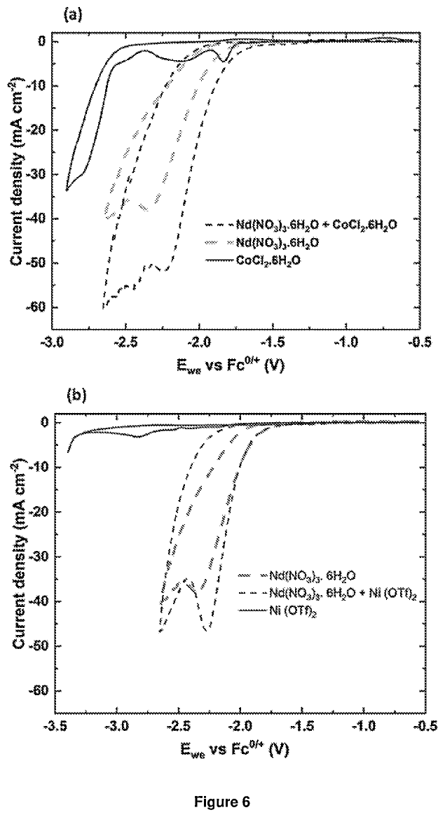

FIG. 6 shows the electrochemical behaviour of Nd(NO₃)₃·6H₂O in [C₄mpyr][DCA] solution in the absence and presence of common metal impurities present in a NiMH battery (e.g. Co and Ni). For that, either 0.15 mol kg⁻¹ CoCl₂·6H₂O and 0.1 mol kg⁻¹ Ni(OTf)₂ were added to the Nd-based electrolyte as an impurity model systems for this study.

As previous reported by the inventors, the electrochemical behaviour of Nd³⁺ in [C₄mpyr][DCA] presents 1 irreversible reduction process at −2.35 V vs Fc^{0/+}. On the other hand, Co²⁺ present one main irreversible reduction process at −2.80 V, a small reduction process at −1.83 V and a broad band centred at −2.13 V vs Fc^{0/+}. The presence of both salts (Nd(NO₃)₃·6H₂O and CoCl₂·6H₂O) in the same electrolyte composition mixture leads to one irreversible reduction process at more positive potentials (ca. 110 mV) and a significant increase in current density from −38 to −52 mA cm⁻². This is extremely interesting/unexpected as less favourable mass transport (e.g. viscosity and conductivity) would be expected in the presence of both Nd³⁺ and Co²⁺, affecting both the kinetics and thermodynamics of the reduction process. This could be related to more favourable Nd speciation in the presence of cobalt salt, or a catalytic effect of cobalt in the electrochemical process.

It was also observed that electrolyte decomposition occurs at more positive potentials than in the mixtures with either Nd³⁺ or Co²⁺ showing noise at potential more negative than −2.3 V (FIG. 6a). This can be the result of larger amount of water in the media, as both salts are hydrated, leading to hydrogen evolution.

FIG. 6b shows the impact of a nickel salt (e.g. Ni(OTf)₂) in a Nd-based electrolyte, and the comparison of the electrolyte solutions with either Ni²⁺ or Nd³⁺. In this case the presence of Ni²⁺ in the Nd-based electrolyte mixture barely affected the onset of the reduction potential which was maintained at −1.7 V, whereas the peak current density increased from −38 to −47 mA cm⁻².

Therefore, in general the presence of Co²⁺ in a Nd-based ionic liquid electrolyte composition of the invention leads to larger current density than in the case of Ni²⁺ as impurity, and in both cases larger than in the absence of impurities.

The experiments demonstrate a higher current density, and in some cases, more positive reduction potential in the presence of common transition metal salts in the electrolyte.

In the case of the system including Ni²⁺, a slightly larger current density is produced in the presence of Ni²⁺, however, the onset reduction potential is similar to that without the Ni²⁺ in the sample.

The experiments demonstrate that the presence of a Co²⁺ impurity leads to larger current density than in the case of Ni²⁺ as impurity. In practice, this means that a larger neodymium deposit is obtained when at least a cobalt impurity is present compared to model systems where only Nd salt is present.

TABLE 3
Summary of onset reduction potentials and peak current
densities for the electrolyte systems in FIG. 6

| | Onset | |
|---|---|---|
| | reduction | Peak current |
| Electrolyte system | potential | density |
| (m = mol kg⁻¹) | (vs Fc^{0/+}) | (mA cm⁻²) |
| 0.5 m Nd(NO₃)₃•6H₂O in [C₄mpyr][DCA] | −1.7 | −38 |
| 0.15 m CoCl₂•6H₂O in [C₄mpyr][DCA] | −1.7 | −5 (at −1.8 |
| | | V), −30 |
| | | (at −2.8 V) |
| 0.1 m Ni(OTf)₂ in [C₄mpyr][DCA] | −2.6 | −3 |
| 0.5 m Nd(NO₃)₃•6H₂O + 0.15 m | −1.6 | −52 |
| CoCl₂•6H₂O in [C₄mpyr][DCA] | | |
| 0.5 m Nd(NO₃)₃•6H₂O + 0.1 m Ni(OTf)₂ in | −1.7 | −47 |
| [C₄mpyr][DCA] | | |

Based on the electrochemical performance of the mixtures of Nd³⁺ containing Co²⁺, and Nd³⁺ containing Ni²⁺, a potential mid-way between the onset of the reduction process and the peak potential was chosen for the electrodeposition (e.g. −2.15 V for the Nd³⁺ containing Co²⁺ mixture and −2.25 V for the Nd³⁺ containing Ni²⁺ mixture). This is to favour the electrodeposition rate while avoiding possible side products resulting from the electrolyte decomposition. After 3.5 hours, the deposits were characterised by SEM using an air sensitive sample holder to limit the oxidation of the sample by contact with the air.

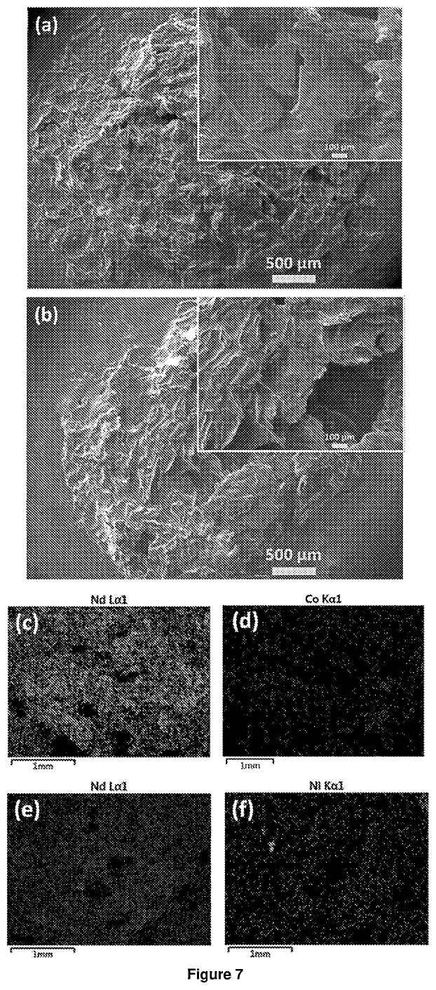

The SEMs of FIG. 7 show similar morphologies (flakes-like) for both deposits also similar to that in the absence of impurities reported above for the nitrate salt system for Example 1. Both deposits showed similar flake-like morphologies (FIGS. 7a and b) and very similar to the one obtained in Example 1 involving Nd-based electrolyte, in the absence of impurities (e.g. Co²⁺ and Ni²⁺). This shows a low impact of either CoCl₂·6H₂O or Ni(OTf)₂ in the Nd deposition mechanism.

EDX mapping shows a uniform deposition of Nd in both electrodeposits. The EDX results shown in FIGS. 7c and b shows that some cobalt is observed in the deposits, but in smaller at % (0.1 at %) in comparison to Nd (1.8 at %). Interestingly, a scarce signal for Ni (0.5 at %) is observed in the electrodeposit with such impurity which is interesting considering that the substrate for the electrodeposition is also Ni. This proves that the electrodeposit is thick and continuous, but also that the surface is mostly composed of Nd. Overall, the at % of Nd in the presence of Co²⁺ impurity is higher than that of in the presence of Ni²⁺ (1.8 vs 1.1 at %).

The charge passed through is in agreement with differences in the amount of Nd atomic percentages (Table 4). It is evident that a significant improvement on charge passed during the electrodeposition process is obtained in the presence of either Co²⁺ or Ni²⁺ in comparison with the sample with only Nd³⁺ (Table 2). The improvement is larger in the case of Co²⁺ as an impurity, which is close to 4 times the charge passed in comparison with the Nd solution in the absence of impurities. The presence of Ni²⁺ as an impurity also led to a significant increase of the charge passed from 0.225 to 0.507 mAh. These results are extremely interesting as translated into a process with high tolerance to impurities. Therefore, the need for additional separation process, translated into cost in time, infrastructure and chemicals will be significantly reduced.

TABLE 4
Summary of the Nd theoretical yield from 0.5 m
Nd(NO₃)₃•6H₂O in [C₄mpyr][DCA] electrolyte
in the presence of 0.15 m CoCl₂•6H₂O and 0.1 m Ni(OTf)₂
at 50° C. (Nd³⁺ reduction time duration = 3.5 hours)

| | Charge | Nd⁰ |
|---|---|---|
| Electrolyte system | passed | Theoretical |
| (m = mol kg⁻¹) | (mAh) | (mg) |
| 0.5 m Nd(NO₃)₃•6H₂O in [C₄mpyr][DCA] | 0.225 | 0.4 |
| 0.5 m Nd(NO₃)₃•6H₂O + 0.15 m | 0.846 | 1.5 |
| CoCl₂•6H₂O in [C₄mpyr][DCA] | | |
| 0.5 m Nd(NO₃)₃•6H₂O + 0.1 m Ni(OTf)₂ in | 0.507 | 0.9 |
| [C₄mpyr][DCA] | | |

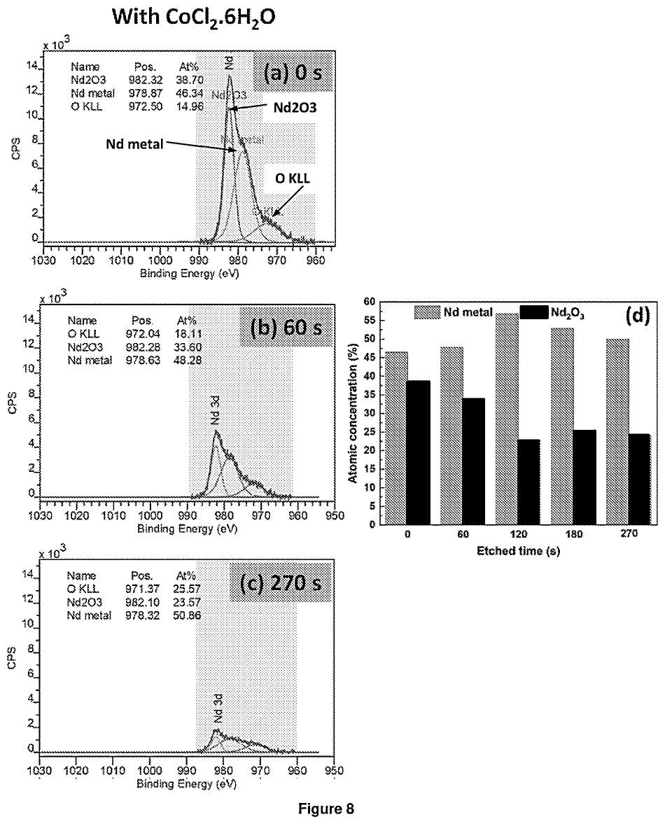

Further characterisation of the electrodeposit was performed using XPS surface and depth profiling to investigate the composition in the inner layers. The Nd 3d_{5/2} spectra analysed for both samples corresponding to various depths from 0 (top layer) to 270 s (inner layers) of etching (FIG. 8a-g). In general, it was observed that in the presence of both Co²⁺ and Ni²⁺ impurities, both Nd metal (979-980 eV) and Nd₂O₃ (>982 eV) are present at all etching times. However, it is worth mentioning that there is a larger amount of metallic Nd than Nd₂O₃ in these electrodeposits. There is also a third component present in the spectra which is attributed to the O KL₂₃L₂₃ auger electron line. Further, in the electrodeposit resulting from the Co²⁺ containing Nd-electrolyte, the Nd₂O₃ atomic concentration (at %) decreases with sample etching depth (i.e., the Nd₂O₃ at % decreases moving closer to the electrode surface) while metallic Nd concentration increases (Nd metal: Nd₂O₃ ratio ranges from 1:1 at the surface of electrodeposit in contact with the electrolyte (0 s etching time) to 1:0.5 approaching the electrode surface (270 s etching time)). The higher Nd₂O₃ on the surface may arise from reactions with atmosphere during sample preparation for XPS.

In the electrodeposit resulting from the Ni²⁺ containing Nd-electrolyte, a relatively higher metallic Nd concentration is observed compared to that of the Nd₂O₃ at all levels within the electrodeposit layer (i.e., at all etching levels) (Nd metal: Nd₂O₃ ratio ranges from 1:0.3 at the surface of electrodeposit in contact with the electrolyte (0 s etching time) to 1:0.5 approaching the electrode surface (at 270 s etching time)). This difference in the Nd metal: Nd₂O₃ ratio in the presence of Co²⁺ and Ni²⁺ impurities may arise from different potentials used for electrodeposition (−2.15 V for the Nd³⁺ containing Co²⁺ mixture and −2.25 V for the Nd³⁺ containing Ni²⁺ mixture) and/or water contents. In contrast, in the electrodeposit obtained from the solution in the absence of Co²⁺ and Ni²⁺ (Example 1), a larger amount of Nd₂O₃ was observed with a ratio Nd metal: Nd₂O₃ of 1:0.7. Therefore, in comparison to the electrodeposit resulted in the absence of the impurities, a higher Nd metal: Nd₂O₃ ratio in favour of more Nd⁰ was observed for the impurity systems.

With etching time increasing, the cobalt signal decreases, suggesting a decrease in amount of Co in the electrodeposit closer to the Ni substrate. This indicates that Co metal is not depositing first on the surface as expected due to lower reduction potential, but simultaneously with Nd. There are no peaks for nickel in the XPS in agreement with the EDX mapping.

### CONCLUSIONS

Rare earth metals (REMs) are considered critical materials due to their extensive demand for use in essential technologies that enable the transition to a greener energy technology and economy. However, the significant environmental and health impact caused by the current primary sourcing of REMs, i.e., mining, urgently demand more sustainable and environmentally friendly alternatives.

The invention provides cleaner approaches to recover Nd via electrochemical deposition, most preferably using low cost and non-fluorinated ionic liquid (IL). In contrast to most typically studied ILs utilising the bis(trifluoromethanesulfonyl)imide (TFSI) anion, the invention enables in a best tested model system, successful electrodeposition of Nd using up to 0.5 mol kg⁻¹ neodymium nitrate (Nd(NO₃)·6H₂O) in N-butyl-N-methylpyrrolidinium dicyanamide ([C₄mpyr][DCA]) IL electrolyte while reporting several times higher current density at a lower temperature (halved to 50° C.) and less controlled environment (H₂O present) compared to parameters previously reported in the literature.

Further, the effect of various Nd salts and their concentration on the electrolyte physical properties, Nd³⁺ electrochemical behaviour, electrodeposit composition and Nd recovery efficiency were investigated using Nd(OTf)₃ (trifluoromethanesulfonate [OTf]⁻) and Nd(NO₃)·6H₂O in [C₄mpyr][DCA] IL electrolytes as model systems. The XPS analysis confirmed the presence of a higher Nd metal content in the electrodeposit resulting from the nitrate system.

Furthermore, the method provides the capability to recover neodymium metal and neodymium oxide by using low cost and fluorine free (i.e. environmentally friendly)N-butyl-N-methylpyrrolidinium dicyanamide ionic liquid-based electrolytes in the presence of common impurities (e.g. Co and Ni) from spent Nickel Metal hydride batteries in concentrations at least up to 10%, 15% 20%, 30% of the total electrolyte composition, preferably from 15% to 30% non-neodymium metal impurity, particularly Co and/or Ni Neodymium was recovered by electrodeposition at low operating temperatures making the recovery process more sustainable and less energy intensive. Interestingly, larger deposits were attained in the presence of impurities than in model systems containing only Nd salt.

The recovered materials are vital for supporting green energy technologies such as wind turbines and electric vehicles.

Some advantages of the invention relate to ease of industry adoption as the method utilises a low cost electrolyte media, less energetic working conditions in the recovery process and a tolerance of water which allow for the process to be used in non-controlled working environment. Additionally, the improved/optimised recovery results in the presence of common impurities, simplify the overall recovery process by eliminating some of the previous separation steps.

1. A method of electrodepositing neodymium from a neodymium salt solution, the method comprising the step of:
electrodepositing neodymium from an electrolyte composition comprising at least one neodymium (III) nitrate salt onto a conductive substrate by electrochemical reduction of neodymium onto the conductive substrate at a temperature of less than 100° C., wherein the electrolyte composition comprises:
one or more ionic liquids comprising a non-halogenated anion,
the at least one neodymium (III) nitrate salt in a concentration at a saturation concentration for the electrolyte composition,
water at a concentration of up to and including 15 wt % of the electrolyte composition, and
one or more non-neodymium metal salt impurities selected from transition metal salt impurities, dissolved in the electrolyte composition as solvent, the non-neodymium metal salt impurities at a concentration of up to 40% (based on mol kg⁻¹) of the neodymium (III) nitrate salt for each non-neodymium metal salt impurity present,
wherein the neodymium electrodeposit formed comprises a ratio of neodymium metal (Nd⁰) to neodymium oxide (Nd₂O₃) of 1:0.5 or better in favour of greater neodymium metal (Nd⁰) in the electrodeposit.

2. The method of claim 1, further comprising the step of:
recovering neodymium from the electrodeposit on the conductive substrate.

3. The method of claim 1, wherein the electrodeposit formed comprises a ratio of neodymium metal (Nd⁰) to neodymium oxide (Nd₂O₃) which is 1:0.45 or better, in favour of greater neodymium metal (Nd⁰) in the electrodeposit.

4. The method of claim 1, wherein the at least one neodymium (III) nitrate salt is in a concentration which is a saturation concentration of the salt for the electrolyte composition.

5. The method of claim 1, wherein an electrochemical reaction occurring during the method produces a peak cathodic current density of −45 mA cm⁻² or greater as determined by cyclic voltammetry at a temperature of 100° C. or less.

6. The method of claim 1, wherein the non-neodymium metal salt impurities are one or more of at least one cobalt salt and/or at least one nickel salt.

7. The method of claim 1, wherein before commencement of the electrodepositing step, the concentration of each non-neodymium metal salt impurity is at least about 0.1 wt % of the neodymium (III) nitrate salt present in the electrolyte composition.

8. The method of claim 1, wherein reduction of the neodymium (III) nitrate salt during the electrodeposition step occurs at −2.5 V vs Fc⁰/Fc⁺ or more positive, preferably at −2.0 V or more positive.

9. The method of claim 1, wherein the electrodeposition involves the step of applying a potential to the substrate of −1.7 V vs Fc⁰/Fc⁺ or less.

10. The method of claim 1, wherein the water is present in the electrolyte composition at a concentration of up to and including 5 wt %.

11. The method of claim 1, wherein the conductive substrate is a metal substrate.

12. (canceled)

13. The method of claim 1, wherein the neodymium (III) nitrate salt is a hydrated neodymium (III) nitrate salt present in the electrolyte composition at concentration of about 0.5 moles kg⁻¹.

14. The method of claim 1, wherein the neodymium (III) nitrate salt is Nd(NO₃)₃·6H₂O.

15. The method of claim 1, wherein the non-halogenated anion of the ionic liquid is a non-fluorinated anion.

16. The method of claim 1, wherein the ionic liquid anion comprises a cyano group (—C═N).

17. The method of claim 1, wherein the ionic liquid comprises a cation selected from a pyrrolidinium cation, a piperidinium cation, an imidazolium cation, a sulfonium cation, a phosphonium cation, guanidinium cation, or an ammonium cation, any of which may be substituted or unsubstituted.

18. (canceled)

19. The method of claim 1, wherein the ionic liquid is a fluorine-free ionic liquid selected from the group consisting of: pyrrolidinium dicyanamide, a piperidinium dicyanamide, an imidazolium dicyanamide, a sulfonium dicyanamide, a phosphonium dicyanamide or an ammonium dicyanamide.

20. (canceled)

21. The method of claim 1, wherein the ionic liquid is N-butyl-N-methylpyrrolidinium dicyanamide, ([C₄mpyr][DCA]).

22. (canceled)

23. (canceled)

24. The method of claim 1, wherein the non-neodymium metal salt impurities comprise at least one cobalt salt and/or at least one nickel salt, and wherein the cobalt salt is CoCl₂·6H₂O and/or the nickel salt is Ni(OTf)₂.

25. (canceled)

26. (canceled)

27. (canceled)

28. (canceled)

29. (canceled)

30. (canceled)

31. (canceled)

32. (canceled)

33. (canceled)

34. An electrolyte composition for neodymium electrodeposition by electrochemical reduction of neodymium onto a conductive substrate at a temperature of less than 100° C., the composition comprising
an ionic liquid comprising a non-halogenated anion;
at least one neodymium (III) nitrate salt in a concentration at a saturation concentration for the electrolyte,
water at a concentration of up to and including 15 wt % of the composition, and
one or more non-neodymium metal salt impurities selected from transition metal salt impurities, dissolved in the electrolyte composition as solvent, the non-neodymium metal salt impurities at a concentration of up to 40% (based on mol kg⁻¹) of the neodymium (III) nitrate salt for each non-neodymium metal salt impurity present.

35. (canceled)

36. (canceled)

37. (canceled)

38. (canceled)
